(19) United States
(12) Patent Application Publication
(10) Pub. No.: US 2019/0264769 A1
(43) Pub. Date: Aug. 29, 2019

(54) COMPOSITE ENERGY-ABSORBING ASSEMBLY HAVING DISCRETE ENERGY-ABSORBING ELEMENTS SUPPORTED BY A CARRIER PLATE

(71) Applicant: GM GLOBAL TECHNOLOGY OPERATIONS LLC, Detroit, MI (US)

(72) Inventors: Ryan GERGELY, Fraser, MI (US); William R. RODGERS, Bloomfield Township, MI (US)

(73) Assignee: GM GLOBAL TECHNOLOGY OPERATIONS LLC, Detroit, MI (US)

(21) Appl. No.: 15/906,793

(22) Filed: Feb. 27, 2018

(51) Int. Cl. F16F 7/12; F16F 7/00; B60R 19/03; B62D 21/15

(52) U.S. Cl. CPC F16F 7/124; F16F 7/003; B60R 19/03; F16F 2226/048; F16F 2224/0241; F16F 2224/0233; B62D 21/15

(57) ABSTRACT

An energy-absorbing assembly for a vehicle includes a carrier plate and a plurality of discrete energy-absorbing elements. The carrier plate includes a first polymer and a first plurality of reinforcing fibers. The plurality of energy-absorbing elements each includes a second polymer and a second plurality of reinforcing fibers. The plurality of energy-absorbing elements is fixed to the carrier plate. Each energy-absorbing element of the first plurality of energy-absorbing elements includes an elongated hollow structure defining a longitudinal axis extending nonparallel to the carrier plate. Another energy-absorbing assembly includes a carrier plate and a plurality of discrete energy-absorbing elements. The carrier plate includes a first polymer and a first plurality of reinforcing fibers. The plurality of energy-absorbing elements each includes a second polymer and a second plurality of reinforcing fibers. Each energy-absorbing element includes a transverse wall and is fixed to the carrier plate.

### GOVERNMENT SUPPORT

This invention was made with government support under DE-EE0006826 awarded by the Department of Energy. The Government has certain rights in the invention.

### INTRODUCTION

The present disclosure relates to a composite energy-absorbing assembly including a carrier plate for supporting discrete energy-absorbing elements, and methods of manufacturing and assembling the energy-absorbing assembly.

This section provides background information related to the present disclosure which is not necessarily prior art.

It is advantageous to improve crush performance of vehicle components. However, it is also advantageous that components of automobiles or other vehicles be lightweight to improve fuel efficiency. Thus, vehicle components that exhibit both adequate strength during normal service and energy-absorption characteristics under extraordinary conditions such as collisions, while minimizing component weight are advantageous.

### SUMMARY

This section provides a general summary of the disclosure, and is not a comprehensive disclosure of its full scope or all of its features.

In various aspects, the present disclosure provides an energy-absorbing assembly for a vehicle. The energy-absorbing assembly includes a carrier plate and a first plurality of discrete energy-absorbing elements. The carrier plate includes a first polymer and a first plurality of reinforcing fibers. The first plurality of discrete energy-absorbing elements each includes a second polymer and a second plurality of reinforcing fibers. The first plurality of energy-absorbing elements is fixed to the carrier plate. Each energy-absorbing element of the first plurality of energy-absorbing elements includes a first elongated hollow structure. Each elongated hollow structure defines a first longitudinal axis. Each first longitudinal axis extends nonparallel to the carrier plate.

In one aspect, the carrier plate defines a plurality of apertures. The first elongated hollow structure of each energy-absorbing element of the first plurality of energy-absorbing elements extends through a respective aperture of the plurality of apertures in the carrier plate.

In one aspect, the energy-absorbing assembly further includes a second plurality of discrete energy absorbing elements. Each energy-absorbing element of the second plurality of energy-absorbing elements includes a third polymer and a third plurality of reinforcing fibers. The second plurality of energy-absorbing elements is fixed to the carrier plate. Each energy-absorbing element of the second plurality of energy-absorbing elements includes a second elongated hollow structure. Each second elongated hollow structure defines a second longitudinal axis extending nonparallel to the carrier plate. The carrier plate includes a first surface and a second surface. Each energy-absorbing element of the first plurality of energy-absorbing elements is fixed to the second surface of the carrier plate. Each energy-absorbing element of the second plurality of energy-absorbing elements is fixed to the first surface of the carrier plate.

In one aspect, the carrier plate includes a first surface and a second surface. One of the first surface and the second surface defines a plurality of depressions. At least a portion of the energy-absorbing elements of the first plurality of energy-absorbing elements are partially disposed within respective depressions of the plurality of depressions.

In one aspect, the carrier plate includes a first surface and a second surface. One of the first surface and the second surface includes a planar portion. At least a portion of the energy-absorbing elements of the first plurality of energy-absorbing elements are fixed to the planar portion of the carrier plate. The first longitudinal axes of the at least a portion of the energy-absorbing elements of the first plurality of energy-absorbing elements extend substantially perpendicular to the planar portion of the carrier plate.

In one aspect, the energy-absorbing assembly further includes a housing. The housing includes a first wall and a second wall. The first wall and the second wall are spaced apart from one another to at least partially define an interior compartment. The carrier plate and the first plurality of energy-absorbing elements are at least partially disposed within the interior compartment. The carrier plate is fixed to the housing.

In one aspect, the first wall of the housing is disposed nonparallel with respect to the second wall of the housing. The first wall forms an angle with respect to the second wall. The carrier plate includes a first surface and a second surface. The first surface is disposed at the angle with respect to the second surface. The first surface of the carrier plate is fixed to the first wall of the housing. The energy-absorbing elements of the first plurality of energy-absorbing elements are fixed to the second surface of the carrier plate. The longitudinal axes of the energy-absorbing elements of the first plurality of energy-absorbing elements extend substantially perpendicular to the second surface of the carrier plate.

In one aspect, the energy-absorbing assembly further includes a second plurality of discrete energy-absorbing elements. Each energy-absorbing element of the second plurality of energy-absorbing elements includes a third polymer and a third plurality of reinforcing fibers. The second plurality of energy-absorbing elements are fixed to the carrier plate. Each energy-absorbing element of the second plurality of energy-absorbing elements includes a second elongated hollow structure. Each second elongated hollow structure defines a second longitudinal axis extending nonparallel to the carrier plate. The carrier plate includes a first surface, a second surface, and a third surface. The third surface extends nonparallel to the second surface. The first surface of the carrier plate is fixed to the first wall. The first plurality of energy-absorbing elements is fixed to the second surface of the carrier plate. The second plurality of energy-absorbing elements is fixed to the third surface of the carrier plate. The first longitudinal axes of the energy-absorbing elements of the first plurality of energy-absorbing elements extend non-parallel to the second longitudinal axes of the energy-absorbing elements of the second plurality of energy-absorbing elements.

In one aspect, the housing further includes a first component and a second component, the first component and the second component cooperate to define the interior compartment. The first component includes the first wall, a first outwardly-extending flange, and a second outwardly-extending flange. The second component includes the second wall, a third outwardly-extending flange, and a fourth outwardly-extending flange. The first outwardly-extending flange extends substantially parallel to the third outwardly-extending flange. The second outwardly-extending flange extends substantially parallel to the fourth outwardly-extending flange. A first portion of the carrier plate is disposed between the first outwardly-extending flange and the third outwardly-extending flange and fixed to the first outwardly-extending flange and the third outwardly-extending flange. A second portion of the carrier plate is disposed between the second outwardly-extending flange and the fourth outwardly-extending flange and fixed to the second outwardly-extending flange and the fourth outwardly-extending flange.

In one aspect, the carrier plate includes a first carrier flange and a second carrier flange. Each of the first carrier flange and the second carrier flange is fixed to an interior surface of the housing to fix the carrier plate to the housing.

In one aspect, each energy-absorbing element of the first plurality of energy-absorbing elements includes a radially-extending flange. The radially-extending flange is fixed to a surface of the carrier plate.

In one aspect, the first polymer is a first thermoplastic polymer. The second polymer is a second thermoplastic polymer.

In various aspects, the present disclosure provides another energy-absorbing assembly for a vehicle. The energy-absorbing assembly includes a carrier plate and a plurality of discrete energy-absorbing elements. The carrier plate includes a first polymer and a first plurality of reinforcing fibers. The plurality of discrete energy-absorbing elements each includes a second polymer and a second plurality of reinforcing fibers. The plurality of energy-absorbing elements are fixed to the carrier plate. Each energy-absorbing element of the plurality of energy-absorbing elements includes a transverse wall.

In one aspect, the respective transverse wall of each energy-absorbing element includes a plurality of elongated ridges formed therein. Each elongated ridge of the plurality of elongated ridges is spaced apart from other elongated ridges of the plurality of elongated ridges at predetermined intervals.

In one aspect, the energy-absorbing assembly further includes a housing. The housing includes a first wall and a second wall. The first wall and the second wall are spaced apart from one another to at least partially define an interior compartment. The carrier plate and the plurality of energy-absorbing elements are at least partially disposed within the interior compartment and the carrier plate is fixed to the housing.

In various aspects, the present disclosure provides a method of assembling an energy-absorbing assembly for a vehicle. The method includes disposing a plurality of energy-absorbing elements on a carrier plate. The carrier plate includes a first polymer and a first plurality of reinforcing fibers. Each energy-absorbing element of the plurality of energy-absorbing elements includes a second polymer and a second plurality of reinforcing fibers. Each energy-absorbing element of the plurality of energy-absorbing elements extends substantially perpendicular to the carrier plate. The method also includes fixing each of the energy-absorbing elements of the plurality of energy-absorbing elements to the carrier plate to form the energy-absorbing subassembly. The first polymer and the second polymer each include a thermoplastic polymer.

In one aspect, each of the energy-absorbing elements of the plurality of energy-absorbing elements includes an elongated hollow structure defining a longitudinal axis. The fixing each of the energy-absorbing elements of the plurality of energy-absorbing elements to the carrier plate includes spin welding to form a thermal joint.

In one aspect, each of the energy-absorbing elements of the plurality of energy-absorbing elements includes an elongated hollow structure defining a longitudinal axis and a radially-extending flange. The radially-extending flange is disposed at an end of the elongated hollow structure. The fixing each of the energy-absorbing elements of the plurality of energy-absorbing elements to the carrier plate includes ultrasonic welding to form a thermal joint.

In one aspect, each of the energy-absorbing elements of the plurality of energy-absorbing elements includes a transverse wall and a flange disposed at an end of the transverse wall. The fixing each of the energy-absorbing elements of the plurality of energy-absorbing elements to the carrier plate includes ultrasonic welding to form a thermal joint.

In one aspect, each of the energy-absorbing elements of the plurality of energy-absorbing elements includes a transverse wall. The fixing each of the energy-absorbing elements of the plurality of energy-absorbing elements to the carrier plate includes vibration welding to form a thermal joint.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an energy-absorbing assembly according to certain aspects of the present disclosure;

FIGS. 2A-2B show an energy-absorbing assembly having a carrier plate fixed to a housing at flanges of the housing according to certain aspects of the present disclosure; FIG. 2A is a side view of the energy-absorbing assembly; FIG. 2B is a front view of the carrier plate of the energy-absorbing assembly of FIG. 2A;

FIGS. 3A-3B show an energy-absorbing assembly having a carrier plate fixed to a housing at a wall of the housing according to certain aspects of the present disclosure; FIG. 3A is a side view of the energy-absorbing assembly; FIG. 3B is a front view of the carrier plate of the energy-absorbing assembly of FIG. 3A;

FIG. 4 is a side view of an energy-absorbing assembly having an angled carrier plate according to certain aspects of the present disclosure;

FIG. 5 is a side view of an energy-absorbing assembly having multiple stages of energy-absorbing elements according to certain aspects of the present disclosure;

FIG. 6 is a side view of another energy-absorbing assembly having multiple stages of energy-absorbing elements and a flanged carrier plate according to certain aspects of the present disclosure;

FIG. 7 is a side view of an energy-absorbing assembly having a curved or faceted carrier plate according to certain aspects of the present disclosure;

FIG. 8 is a top view of another energy-absorbing assembly having a curved or faceted carrier plate according to certain aspects of the present disclosure;

FIG. 9 is a front view of an energy-absorbing subassembly having energy-absorbing elements disposed in an offset arrangement according to certain aspects of the present disclosure;

FIG. 10 is a front view of an energy-absorbing subassembly having energy-absorbing elements disposed in a space-filling arrangement according to certain aspects of the present disclosure;

FIG. 11 is a front view of an energy-absorbing subassembly having energy-absorbing elements disposed in a nested arrangement according to certain aspects of the present disclosure;

FIG. 12 shows an energy-absorbing subassembly according to certain aspects of the present disclosure;

FIG. 13 shows another energy-absorbing subassembly according to certain aspects of the present disclosure;

FIG. 14 shows yet another energy-absorbing subassembly according to certain aspects of the present disclosure;

FIG. 15 shows another energy-absorbing subassembly according to certain aspects of the present disclosure;

FIGS. 16A-16C show side views of a method of assembling an energy-absorbing subassembly via spin welding according to certain aspects of the present disclosure; FIG. 16A shows a first energy-absorbing element being assembled to a carrier plate; FIG. 16B shows a second energy-absorbing element being assembled to the carrier plate; FIG. 16C shows the subassembly;

FIGS. 17A-17C show partial side views of a method of assembling an energy-absorbing subassembly via ultrasonic spot welding according to certain aspects of the present disclosure; FIG. 17A shows a carrier plate being placed in an anvil; FIG. 17B shows an annular holding clamp being attached to an energy-absorbing element; FIG. 17C shows an ultrasonic joining tool forming a solid state weld to fix the energy-absorbing element to the carrier plate;

FIG. 18 shows a side view of a method of assembling an energy-absorbing assembly via ultrasonic spot welding according to certain aspects of the present disclosure;

FIG. 19 shows a front view of a method of assembling an energy-absorbing assembly via vibration welding according to certain aspects of the present disclosure; and

FIGS. 20A-20B show side views of a method of assembling an energy-absorbing assembly via press fitting according to certain aspects of the present disclosure; FIG. 20A shows an energy-absorbing element being moved toward a carrier plate; and FIG. 20B shows the energy-absorbing element fixed to the carrier plate.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

Energy-absorbing assemblies (or crush assemblies) are used in vehicles to absorb collision energy through controlled deformation. Energy-absorbing assemblies may be constructed from metal, such as aluminum or steel, or polymeric materials, such as injection molded polymers or fiber-reinforced polymeric composites. Metal crush members typically absorb energy as molecules slide past one another to deform the component without fracturing. Metal energy-absorbing assemblies may be heavy and complicated compared to composite energy-absorbing assemblies. Metal energy-absorbing assemblies may be time-intensive to assemble because of a large quantity of components. For example, a single metal energy-absorbing assembly may include several bulkheads that are individually fabricated (e.g., by stamping) and fixed to one another (e.g., by welding).

Polymeric energy-absorbing assemblies may be formed by injection molding. As a result, existing polymeric energy-absorbing assemblies may be free of reinforcing fibers, or may include very short reinforcing fibers. Some polymeric energy-absorbing assemblies may include an internal honeycomb structure. The honeycomb structure may include a plurality of uniformly sized, spaced, and shaped cells, with adjacent cells sharing walls. The walls have a uniform thickness. Because of the intricate tooling required, injected-molded polymeric energy-absorbing assemblies are generally difficult to tailor to specific vehicles or loading conditions.

Fiber-reinforced composite materials include a polymeric matrix having a reinforcing material distributed therein. Generally, fiber-reinforced composite crush members absorb energy through fragmentation, pulverization, fronding, tearing, interlaminar debonding, intralaminar debonding, fiber-matrix debonding, and fiber pullout failure modes, by way of non-limiting example. Suitable reinforcing materials include carbon fibers, glass fibers (e.g., fiber glass, quartz), basalt fibers, aramid fibers (e.g., KEVLAR®, polyphenylene benzobisoxazole (PBO)) polyethylene fibers (e.g., high-strength ultra-high molecular weight (UHMW) polyethylene), polypropylene fibers (e.g., high-strength polypropylene), natural fibers (e.g., cotton, flax, cellulose, spider silk), and combinations thereof, by way of non-limiting example. The reinforcing materials may be fabricated as woven fabric, continuous random fabric, discontinuous random fibers, chopped random fabric, continuous strand unidirectional plies, oriented chopped strand plies, braided fabric and any combinations thereof. The polymeric matrix may be a thermoplastic polymer or a thermoset polymer.

In various aspects, the present disclosure provides a composite energy-absorbing assembly. The composite energy-absorbing assembly may include a carrier plate and multiple discrete energy-absorbing elements fixed to the carrier plate. The carrier plate with the discrete energy-absorbing elements may be at least partially disposed within an interior compartment of a housing. Use of the carrier plate may simplify manufacturing and assembly of the energy-absorbing assembly by facilitating proper alignment of the energy-absorbing elements within the housing. Furthermore, the carrier plate and energy-absorbing elements can be fixed to one another to form a subassembly prior to insertion of either component into the interior compartment of the housing. The energy-absorbing elements and the carrier plate can optionally be manufactured and assembled to form the energy-absorbing subassembly at a distinct location prior to assembly within the housing. The above pre-fabrication process may facilitate a relatively quick assembly of the subassembly into the housing to form the energy-absorbing assembly at a later time. The carrier plate may also augment structural performance of the housing and improve retention of the energy-absorbing elements within the housing, particularly during impacts to the energy-absorbing assembly. The carrier plate may retain the energy-absorbing elements in place during crush, reducing the occurrence of a separation of the energy-absorbing elements from the carrier plate prior to being fully crushed (e.g., absorbing a maximum amount of energy). Therefore, the use of the carrier plate may improve the crush performance of the energy-absorbing assembly. In certain aspects, the carrier plate and the energy-absorbing elements may both include thermoplastic polymers. The energy-absorbing elements can therefore advantageously be joined to the carrier plate via thermal joining techniques.

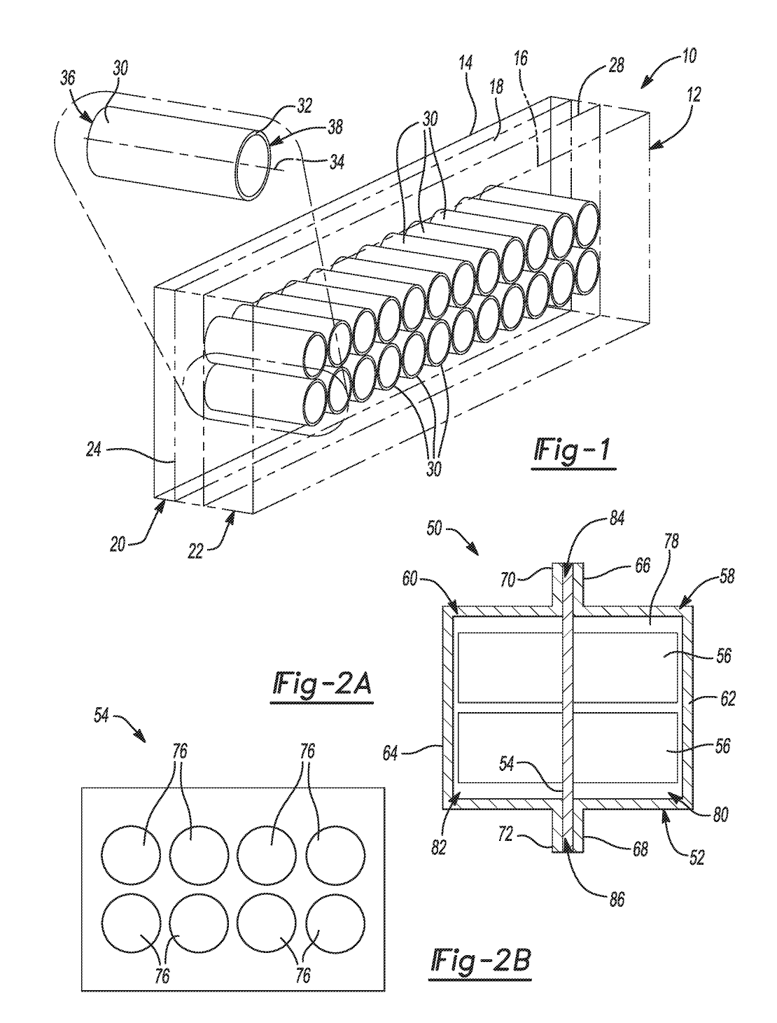

With reference to FIG. 1, an energy-absorbing assembly 10 according to certain aspects of the present disclosure is provided. The energy-absorbing assembly 10 may include a housing 12. The housing 12 may include a first wall 14 and a second wall 16 (shown in skeleton). The first wall 14 may be spaced apart from the second wall 16 to at least partially define an interior compartment 18. The energy-absorbing assembly 10 may be fixed to a vehicle. For example, the housing 12 of the energy-absorbing assembly 10 may be fixed to an exterior of the vehicle.

The housing 12 may include a first component 20 and a second component 22 that are joined at a seam 24. The first component 20 and the second component 22 may cooperate to at least partially define the interior compartment 18. The first and second components 20, 22 are merely exemplary, and in various alternative embodiments, the housing 12 may include other quantities of components.

The second wall 16 may be disposed outward (i.e., outboard) of the first wall 14 with respect to the vehicle. In one example, the energy-absorbing assembly 10 may be a rocker panel or a portion of a rocker panel. The rocker panel can be fixed to an exterior of the vehicle and may extend along a side of the vehicle between front and rear wheel well openings. The first wall 14 may be disposed closer than the second wall 16 to a passenger cabin or center of the vehicle. In another example, the energy-absorbing assembly 10 may be a bumper beam or a portion of a bumper beam. The bumper beam may extend along a front of the vehicle. The first wall 14 may be closer to a rear of the vehicle than the second wall 16. The second wall 16 may be closer to a front of the vehicle than the first wall 14.

The first wall 14 may be substantially planar as shown, or the first wall 14 may alternatively be contoured, such as to complement to an exterior contour of the vehicle. The second wall 16 may be substantially planar as shown, or the second wall 16 may alternatively be contoured based on desired performance or appearance characteristics of the energy-absorbing assembly 10. The first wall 14 may extend substantially parallel to the second wall 16. In various alternative aspects, the first wall 14 and the second wall 16 may be non-parallel to one another. The first and second components 20, 22 may include different or additional features, such as flanges, ribs, and additional walls, by way of non-limiting example. As referred to herein, the word “substantially,” when applied to a characteristic of an element described, indicates that there may be a minor variation in the characteristic beyond what is exactly specified (for example, variation due to manufacturing tolerances) without having a substantial effect on the mechanical or physical attributes of the element.

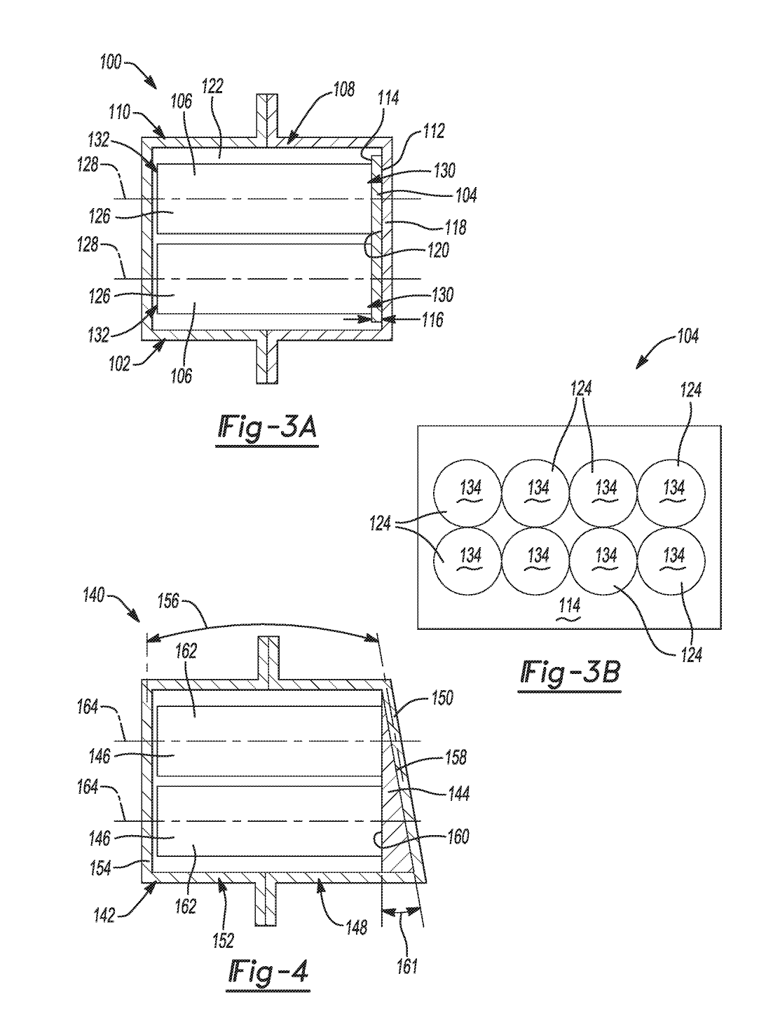

The energy-absorbing assembly 10 may further include a carrier plate 28 and a plurality of discrete energy-absorbing elements 30. In various aspects, the carrier plate 28 may be referred to as a stringer. The carrier plate 28 may structurally support the energy-absorbing elements 30. The carrier plate 28 may optionally structurally support the housing 12. The carrier plate 28 may be fixed to the housing 12, thereby fixing the energy-absorbing elements 30 to the housing 12. The carrier plate 28 may be fixed to the second component 22 and disposed outboard of the seam 24, as shown. However, in alternative embodiments, the carrier plate 28 may optionally be fixed to the first component 20 and disposed inboard of the seam 24 (see, e.g., FIG. 3A). In other alternative embodiments, the carrier plate 28 may be fixed to both the first component 20 and the second component 22 and disposed coincident or aligned with the seam 24 (see, e.g., FIG. 2A). The carrier plate 28 is described in greater detail below.

The energy-absorbing elements 30 may be discontinuous such that they do not share walls with one another. Because the energy-absorbing elements 30 are distinct components, the configuration and placement of energy-absorbing elements 30 can be optimized for anticipated crush conditions. The energy-absorbing elements 30 can be optimized by changing the size, shape, and/or distribution of energy-absorbing elements 30 within the housing 12.

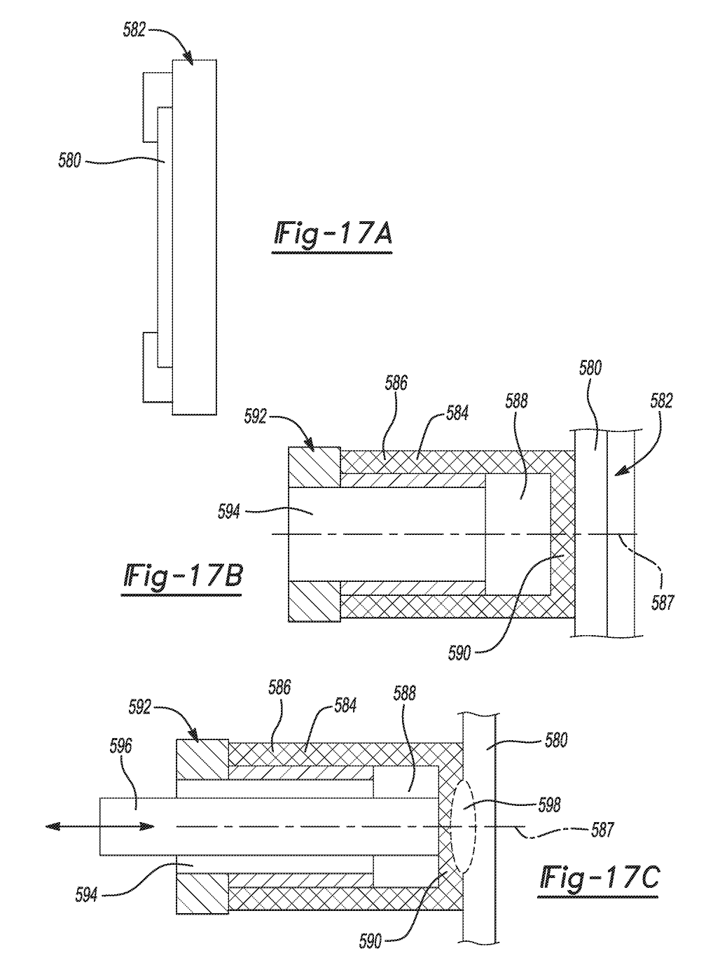

Each of the energy-absorbing elements 30 may include an elongated hollow structure 32 defining a longitudinal axis 34. The elongated hollow structure 32 may extend between a first end 36 of the energy-absorbing element 30 and a second end 38 of the energy-absorbing element 30 opposite the first end 36. The first end 36 and the second end 38 may be open. However, in alternative aspects, one or both of the first end 36 and the second end 38 may include an end cap (see, e.g., flange 590 of energy-absorbing element 584 of FIGS. 17A-17C). In various aspects, the energy-absorbing element 30 may be symmetric about the longitudinal axis 34.

The energy-absorbing elements 30 may be fixed to the carrier plate 28 such that the longitudinal axis 34 of each energy-absorbing element 30 extends substantially non-parallel to the carrier plate 28. In one example, the respective longitudinal axes 34 of the energy-absorbing elements 30 may extend substantially perpendicular to the carrier plate 28. Where the first wall 14 is contoured or curved, the longitudinal axes 34 may extend substantially normal to a tangent plane of the curve.

The elongated hollow structure 32 of each energy-absorbing element 30 of the plurality of energy-absorbing elements may define a substantially circular cross section in a direction perpendicular to the longitudinal axis 34. The elongated hollow structure 32 may define a tube or cylinder. In other examples, the elongated hollow structure 32 may define alternative shapes, such as a conical frustum. The energy-absorbing elements 30 may include different or additional features, such as a flange for mounting the energy-absorbing element 30 to the carrier plate 28 (see, e.g., flange 590 on energy-absorbing element 584 of FIG. 17B).

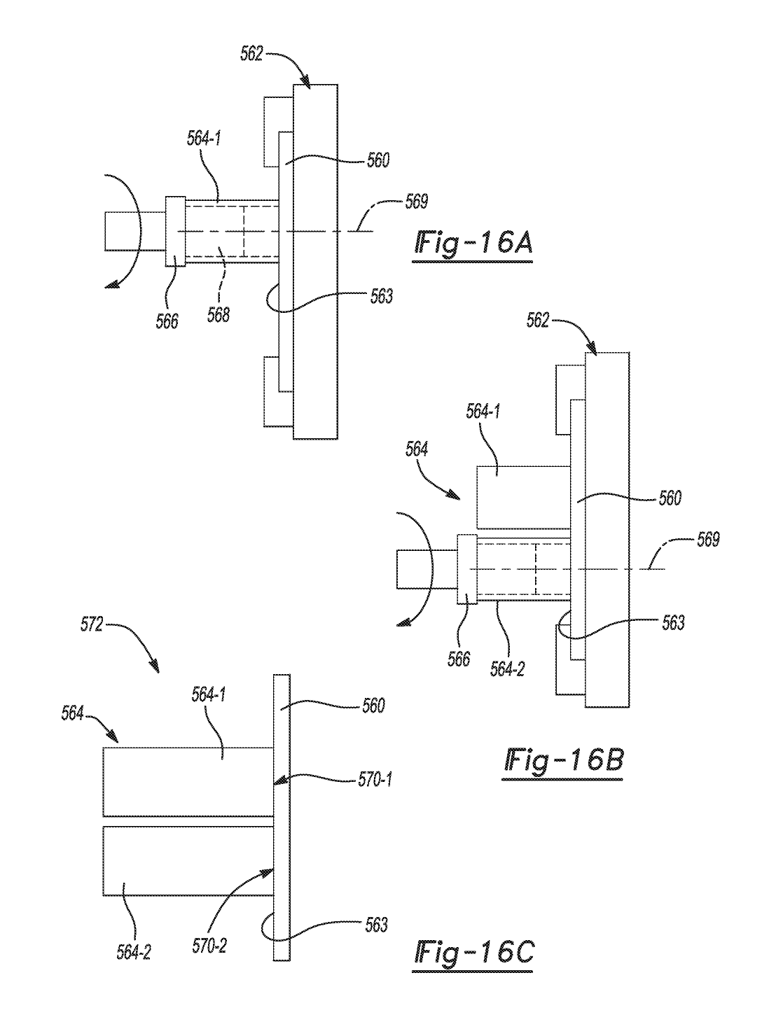

The carrier plate 28 may be formed from or include a first composite material including a first polymer and a first plurality of reinforcing fibers. However, in various alternative embodiments, the carrier plate 28 may be formed from or include a first metallic material, such as aluminum or steel, by way of non-limiting example. Each of the energy-absorbing elements 30 may be formed from or include a second composite material including a second polymer and a second plurality of reinforcing fibers. The housing 12 may be formed from or include a third composite material or a second metallic material. The third composite material may include a third polymer and a third plurality of reinforcing fibers. The second metallic material may include aluminum or steel, by way of non-limiting example. The first, second, and third polymers may include thermoplastic resins or thermoset resins. The first, second, and third polymers may be distinct from one another or alternatively, the first, second, and third polymers may be the same. Furthermore, the energy-absorbing assembly 10 may include both thermoplastic and thermoset polymers. In various aspects, the carrier plate 28 and the energy-absorbing elements 30 may each be formed from or include a thermoplastic resin. In certain embodiments, the first and second polymers are the same or similar so that the energy-absorbing elements 30 can be thermally joined to the carrier plate 28, as discussed in greater detail below (FIGS. 16A-20B).

The thermoplastic resin may include: polyethylenimine (PEI), polyamide-imide (PAI), polyamide (PA) (e.g., nylon 6, nylon 66, nylon 12), polyetheretherketone (PEEK), polyetherketone (PEK), a polyphenylene sulfide (PPS), a thermoplastic polyurethane (TPU), polypropylene (PP), polycarbonate/acrylonitrile butadiene styrene (PC/ABS), high-density polyethylene (HDPE), polyethylene terephthalate (PET), poly(methyl methacrylate) (PMMA), polycarbonate (PC), polyaryletherketone (PAEK), polyetherketoneketone (PEKK), co-polymers thereof, and combinations thereof. The thermoset polymers may include: benzoxazine, a bis-maleimide (BMI), a cyanate ester, an epoxy, a phenolic (PF), a polyacrylate (acrylic), a polyimide (PI), an unsaturated polyester, a polyeurethane (PUR), a vinyl ester, a siloxane, polydicyclopentadiene (PDCPD), co-polymers thereof, and combinations thereof.

The reinforcing fibers may include: carbon fibers, glass fibers (e.g., fiber glass, quartz), basalt fibers, aramid fibers (e.g., KEVLAR®, polyphenylene benzobisoxazole (PBO), polyethylene fibers (e.g., ultra-high molecular weight polyethylene (UHMWPE)), polypropylene fibers (e.g., high-strength polypropylene) natural fibers (e.g., cotton, flax, cellulose, spider silk), and combinations thereof. The reinforcing fibers may be fabricated as woven fabric, continuous random fabric, discontinuous random fibers, chopped random fabric, continuous strand unidirectional plies, oriented chopped strand plies, braided fabric, and combinations thereof.

As appreciated by those of skill in the art, the composite material may further include other conventional ingredients, including other reinforcement materials, functional fillers or additive agents, like organic/inorganic fillers, fire-retardants, anti-ultraviolet radiation agents (UV stabilizers), anti-oxidants, colorants, mold release agents, softeners, plasticizing agents, surface active agents, and the like.

With reference to FIGS. 2A-2B an energy-absorbing assembly 50 according to certain aspects of the present disclosure is provided. The energy-absorbing assembly 50 may include a housing 52, a carrier plate 54, and a plurality of energy-absorbing elements 56. Unless otherwise described, the energy-absorbing assembly 50 may be similar to the energy-absorbing assembly 10 of FIG. 1.

The housing 52 may include a first component 58 and a second component 60. The first component 58 may include a first wall 62 and the second component 60 may include a second wall 64. The second component 60 may disposed outward of the first component 58 with respect to the vehicle. The first component 58 may include a first or upper outwardly-extending flange 66 and a second or lower outwardly-extending flange 68. The second component 60 may include a third or upper outwardly-extending flange 70 and a fourth or lower outwardly-extending flange 72. The first outwardly-extending flange 66 and the third outwardly-extending flange 70 may extend substantially parallel to or complement one another. The second outwardly-extending flange 68 and the fourth outwardly-extending flange 72 may extend substantially parallel to or complement one another. In various aspects, the first outwardly-extending flange 66 and the second outwardly-extending flange 68 may project away from the first component 58 such that the first and second outwardly-extending flanges 66, 68 extend substantially perpendicular to adjacent portions of the first component 58. The third outwardly-extending flange 70 and the fourth outwardly-extending flange 72 may project away from the second component 60 such that the third and fourth outwardly-extending flanges 70, 72 extend substantially perpendicular to adjacent portions of the second component 60.

The carrier plate 54 may define a plurality of apertures 76. The energy-absorbing elements 56 of the plurality of energy-absorbing elements may extend through respective apertures 76 of the plurality of apertures. Thus, the energy-absorbing elements 56 may be at least partially disposed within the respective apertures 76. The energy-absorbing elements 56 may be fixed to the carrier plate 54 (e.g., by press-fitting, thermal joining, or a combination thereof). In various alternative aspects, when the energy-absorbing elements 56 are closely packed together (i.e., in direct physical contact with one another), the carrier plate 54 may include a single aperture that conforms to a periphery of the plurality of closely-packed energy-absorbing elements 56 (not shown).

The first component 58 and the second component 60 of the housing 52 may cooperate to define an interior compartment 78. The carrier plate 54 and the energy-absorbing elements 56 may be at least partially disposed within the interior compartment 78. The carrier plate 54 may extend through the interior compartment 78, dividing the interior compartment into a first interior portion 80 and a second interior portion 82. The carrier plate 54 may extend through a center of the interior compartment 78, so that the first interior portion 80 and the second interior portion 82 have substantially similar volumes. However, in various alternative aspects, the carrier plate 54 may be offset from the center of the interior compartment 78, dividing the interior compartment 78 into first and second interior portions having unequal volumes.

The carrier plate 54 may be disposed between the first component 58 and the second component 60. The carrier plate 54 may be fixed to the housing 52 at the first, second, third, and fourth outwardly-extending flanges 66, 68, 70, 72. More particularly, a first or top portion 84 of the carrier plate 54 may be disposed between and fixed to the first outwardly-extending flange 66 and the third outwardly-extending flange 70. A second or bottom portion 86 of the carrier plate 54 may be disposed between and fixed to the second outwardly-extending flange 68 and the fourth outwardly-extending flange 72.

Referring to FIGS. 3A-3B, another energy-absorbing assembly 100 according to certain aspects of the present disclosure is provided. Unless otherwise described, the energy-absorbing assembly 100 may be similar to the energy-absorbing assembly 50 of FIG. 2A. The energy-absorbing assembly 100 may include a housing 102, a carrier plate 104, and a plurality of energy-absorbing elements 106. The housing 102 may include a first component 108 and a second component 110 disposed outward of the first component 108 with respect to a vehicle when the energy-absorbing assembly 50 is fixed to the vehicle.

The carrier plate 104 may include a first surface 112 and a second surface 114 disposed opposite the first surface 112. The first surface 112 and the second surface 114 may extend substantially parallel to one another so that the carrier plate 104 defines a uniform thickness 116. In various aspects, when the carrier plate 104 is formed from or includes a polymeric composite material, the thickness 116 of the carrier plate 104 may be greater than or equal to about 1 mm to less than or equal to about 15 mm, optionally greater than or equal to about 2 mm to less than or equal to about 10 mm, and optionally greater than or equal to about 2.5 mm to less than or equal to about 4 mm. In various other aspects, when the carrier plate 104 is formed from or includes steel, the thickness 116 of the carrier plate 104 may be greater than or equal to about 0.3 mm to less than or equal to about 2 mm, optionally greater than or equal to about 0.4 mm to less than or equal to about 1.5 mm, and optionally greater than or equal to about 0.5 mm to less than or equal to about 0.7 mm. In various other aspects, when the carrier plate 104 is formed from or includes aluminum, the thickness 116 of the carrier plate 104 may be greater than or equal to about 0.5 mm to less than or equal to about 4 mm, optionally greater than or equal to about 0.7 mm to less than or equal to about 2 mm, and optionally greater than or equal to about 0.8 mm to less than or equal to about 1 mm.

The carrier plate 104 may be fixed to the first component 108 of the housing 102. More particularly, the first surface 112 of the carrier plate 104 may be fixed to a first wall 118 of the first component 108. The first surface 112 of the carrier plate 104 may extend substantially parallel to or complement a third surface 120 of the first wall 118. Unlike the energy-absorbing assembly 50 of FIG. 2A, the energy-absorbing assembly 100 may include a single interior compartment 122 defined by the first and second components 108, 110 of the housing 102.

The plurality of energy-absorbing elements 106 may be fixed to the second surface 114 of the carrier plate 104. The second surface 114 of the carrier plate 104 may define a plurality of depressions 124. Each energy-absorbing element 106 may include an elongated hollow structure 126 defining a longitudinal axis 128. Each energy-absorbing element 106 of the plurality of energy-absorbing elements may extend between a first end 130 and a second end 132. Each energy-absorbing element 106 may be at least partially disposed within a respective depression 124. More specifically, the first end 130 of each energy-absorbing element 106 may be at least partially disposed within a respective depression 124. Each respective longitudinal axis 128 of the elongated hollow structures 126 may extend substantially perpendicular to a fourth surface 134 of a respective depression 124. The depressions 124 may facilitate proper alignment and spacing of the energy-absorbing elements 106 with respect to one another and the housing 102. Each energy-absorbing element 106 may optionally include a radially-extending flange (i.e., a radially-inwardly-extending flange or a radially-outwardly-extending flange) to enable the creation of a stronger joint between the energy-absorbing element 106 and the carrier plate 104 (not shown).

In various alternative aspects, the second surface 114 of the carrier plate 104 may be planar and therefore free of depressions. When the carrier plate 104 includes a planar second surface 114, the respective first ends 130 of each energy-absorbing element may be butt-welded to the second surface 114 of the carrier plate 104, by way of non-limiting example.

With reference to FIG. 4, yet another energy-absorbing assembly 140 according to certain aspects of the present disclosure is provided. Unless otherwise described, the energy-absorbing assembly 140 may be similar to the energy-absorbing assembly 100 of FIG. 3A. The energy-absorbing assembly 140 may include a housing 142, a carrier plate 144, and a plurality of energy-absorbing elements 146. The housing 142 may include a first component 148 including a first wall 150 and a second component 152 including a second wall 154. The second component 152 may be disposed outward of the first component 148 with respect to the vehicle when the energy-absorbing assembly 140 is fixed to a vehicle. In various aspects, the first wall 150 and the second wall 154 may extend non-parallel to one another. By way of non-limiting example, the first wall 150 may be disposed at an angle of greater than zero with respect to the second wall 154. The first wall 150 may be angled with respect to the second wall 154 as required by a body of the vehicle, for example.

The vehicle may be operable to travel along the ground. In various aspects, it may be desirable for the energy-absorbing elements 146 to extend substantially parallel to the ground. Thus, when the first wall 150 and the second wall are disposed non-parallel to one another as shown, the carrier plate 144 may be angled to facilitate orientation of the energy-absorbing elements 146 parallel to the ground. In various aspects, the carrier plate 144 may be referred to as an “angled carrier plate.” When the energy-absorbing assembly 140 is fixed to the vehicle that is operable to travel along the ground, the second wall 154 may be disposed substantially perpendicular to the ground. The first wall 150 may be disposed non-perpendicular to the ground and non-parallel to the first wall 150. More particularly, the first wall 150 may be disposed at a first angle 156 with respect to the second wall 154.

The carrier plate 144 may include a first surface 158 and a second surface 160. The first surface 158 may be disposed at a second angle 161 with respect to the second surface 160. The second angle 161 may have substantially the same magnitude as the first angle 156. The carrier plate 144 may be fixed to the housing 142. More specifically, the first surface 158 of the carrier plate 144 may be fixed to the first wall 150 of the housing 142. The first surface 158 of the carrier plate 144 may extend substantially parallel to the first wall 150. Thus, the second surface 160 of the carrier plate 144, which is disposed at the second angle 161 with respect to the first surface 158 of the carrier plate 144, is oriented substantially parallel to the second wall 154 of the housing 142 and substantially perpendicular to the ground.

The energy-absorbing elements 146 are fixed to the second surface 160 of the carrier plate 144. Each energy-absorbing element 146 may include an elongated hollow structure 162 defining a longitudinal axis 164. The longitudinal axes 164 of the respective energy-absorbing elements 146 may extend substantially perpendicular to the second surface 160 of the carrier plate 144 and substantially parallel to the ground. Thus, the first surface 158 of the carrier plate 144 may conform to the first wall 150 and orient the energy-absorbing elements 146 to be substantially parallel to the ground.

Some energy-absorbing assemblies according to certain aspects of the present disclosure, which may be referred to as “multi-stage energy-absorbing assemblies,” include multiple pluralities of energy-absorbing elements. Thus, multi-stage energy-absorbing assemblies are capable of multi-stage responses to an applied load. For example, a light impact may crush or partially crush outmost or primary stage energy-absorbing elements, while leaving innermost or secondary stage energy-absorbing elements substantially intact.

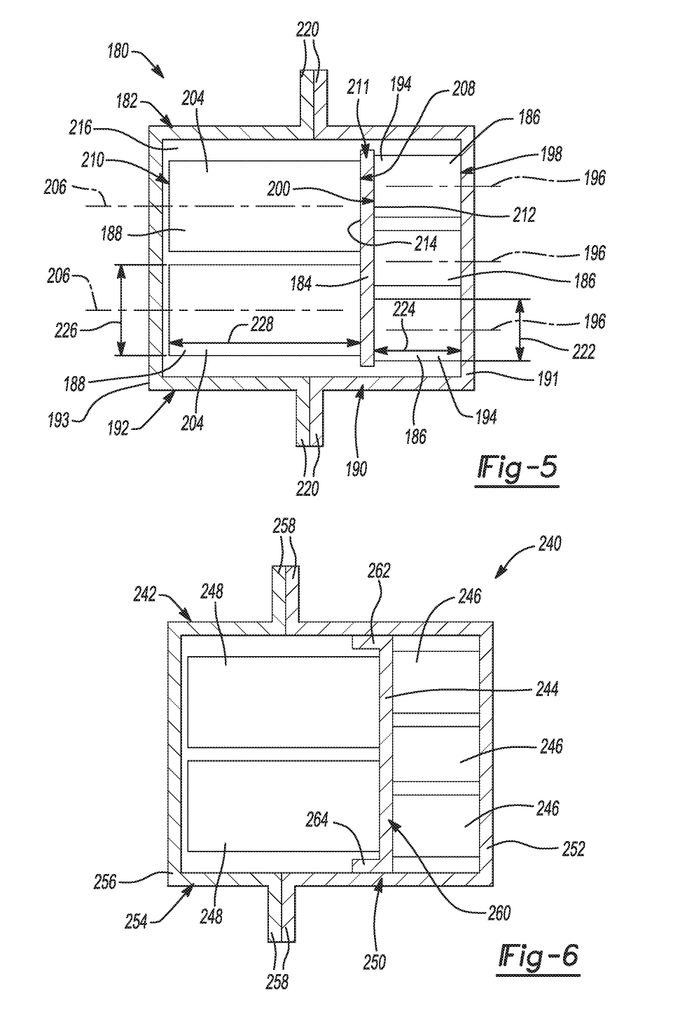

Referring to FIG. 5, another energy-absorbing assembly 180 according to certain aspects of the present disclosure is provided. Unless otherwise provided, the energy-absorbing assembly 180 may be similar to the energy-absorbing assembly 100 of FIG. 3A. The energy-absorbing assembly 180 may include a housing 182, a carrier plate 184, a first plurality of energy-absorbing elements 186, and a second plurality of energy-absorbing elements 188. The carrier plate 184 may be formed from or include a first polymer and a first plurality of reinforcing fibers. The energy-absorbing elements 186 of the first plurality of energy-absorbing elements may be formed from or include a second polymer and a second plurality of reinforcing fibers. The energy-absorbing elements 188 of the second plurality of energy-absorbing elements may be formed from or include a third polymer and a third plurality of reinforcing fibers. The housing 182 may include a first component 190 including a first wall 191 and a second component 192 including a second wall 193 disposed outward of the first component 190 with respect to a vehicle when the energy-absorbing assembly is fixed to the vehicle.

Each energy-absorbing element 186 of the first plurality of energy-absorbing elements may include a first elongated hollow structure 194 defining a first longitudinal axis 196. The energy absorbing elements 186 of the first plurality of energy-absorbing elements may each extend between a first end 198 and a second end 200. Each energy-absorbing element 188 of the second plurality of energy-absorbing elements may include a second elongated hollow structure 204 defining a second longitudinal axis 206. The energy-absorbing elements 188 of the second plurality of energy-absorbing elements may each extend between a third end 208 and a fourth end 210.

The energy-absorbing elements 186 of the first plurality of energy-absorbing elements and the energy-absorbing elements 188 of the second plurality may be fixed to the carrier plate 184 to form a subassembly 211. The carrier plate 184 may include a first surface 212 and a second surface 214. The first surface 212 and the second surface 214 of the carrier plate 184 may extend substantially parallel to one another. The energy-absorbing elements 186 of the first plurality may be fixed to the first surface 212 of the carrier plate 184. More particularly, the respective second ends 200 of the energy-absorbing elements 186 of the first plurality may be fixed to the first surface 212 of the carrier plate 184. The energy-absorbing elements 188 of the second plurality of energy-absorbing elements may be fixed to the second surface 214 of the carrier plate 184. More particularly, the respective third ends 208 of the energy-absorbing elements 188 of the second plurality of energy-absorbing elements may be fixed to the second surface 214 of the carrier plate 184.

The subassembly 211 may be at least partially disposed within an interior compartment 216 defined by the first and second components 190, 192 of the housing 182. The subassembly 211 may be fixed to the housing, such as at the first wall 191 of the first component 190. In various aspects, the respective first ends 198 of the energy-absorbing elements 186 of the first plurality of energy-absorbing elements may be directly fixed to the first wall 191 of the housing 182. The energy-absorbing elements 186 of the first plurality of energy-absorbing elements may be fixed to the first wall 191 by adhesive, mechanical fasteners, thermal bonding, combinations thereof, or any other suitable method. In various aspects, the carrier plate 184 may not contact the housing 182 at all. Fixing the subassembly 211 to the housing 182 at the respective first ends 198 of the first plurality of energy-absorbing elements 186 may be advantageous when the carrier plate 184 is not aligned with flanges 220 of the housing, or where the housing 182 does not have flanges 220. In various alternative aspects, the subassembly 211 may further include a second carrier plate (not shown) disposed between the first plurality of energy-absorbing elements 186 and the first wall 191 to facilitate joining the first plurality of energy-absorbing elements 186 to the first wall 191.

As described above, the multi-stage energy-absorbing assembly 180 may advantageously create two or more different responses to a single applied load. In various aspects, the second plurality of energy-absorbing elements 188 may be referred to as a primary stage and the first plurality of energy-absorbing elements 186 may be referred to as a secondary stage. The energy-absorbing elements 186, 188 of the respective pluralities or stages may be different, such as due to shape (e.g., cylindrical, conical), size (e.g., length, diameter), and materials of construction (e.g., polymers and reinforcing fibers). Here, the energy-absorbing elements 186 of the first plurality of energy-absorbing elements define a first diameter 222 and a first length 224. The energy-absorbing elements 188 of the second plurality define a second diameter 226 and a second length 228. The first diameter 222 may be less than the second diameter 226 and the first length 224 may be less than the second length 228.

In certain loading conditions, one of the primary stage and the secondary stage may crush before the other of the primary stage and the secondary stage. In one non-limiting example, an impact to an outermost side of the energy-absorbing assembly 180 (i.e., the second wall 193) may cause crush of the primary stage while leaving the secondary stage intact. The multi-stage response may also make it possible to repair and replace only a portion of the energy-absorbing assembly 180 after crush.

With reference to FIG. 6, yet another energy-absorbing assembly 240 according to certain aspects of the present disclosure is provided. Unless otherwise provided, the energy-absorbing assembly 240 may be similar to the energy-absorbing assembly 180 of FIG. 5. The energy-absorbing assembly 240 may include a housing 242, a carrier plate 244, a first plurality of energy-absorbing elements 246, and a second plurality of energy-absorbing elements 248.

The housing 242 may include a first component 250 including a first wall 252 and a second component 254 including a second wall 256. The second component 254 may be disposed outward of the first component 250 with respect to a vehicle when the energy-absorbing assembly 240 is fixed to the vehicle. The first component 250 and the second component 254 may be joined together or fixed to one another at outwardly-extending flanges 258.

The first plurality of energy-absorbing elements 246 and the second plurality of energy-absorbing elements 248 may be fixed to the carrier plate 244 to form a subassembly 260. The carrier plate 244 may include a first carrier flange 262 and a second carrier flange 264. In various aspects, the carrier plate 244 may be referred to as a “flanged carrier plate.” The first carrier flange 262 and the second carrier flange 264 may extend substantially parallel to one another. The carrier plate 244 may be fixed to the housing 242 at the first and second flanges 262, 264. The carrier plate 244 may be fixed to the housing 242 by adhesive, mechanical fasteners, thermal joining, or any other suitable methods known to those skilled in the art. Unlike certain other embodiments where the carrier plate is fixed between first and second components (e.g., energy-absorbing assembly 50 of FIG. 2A), the carrier plate 244 may be fixed to a single component of the housing 242, such as the first component 250 shown here. In various aspects, the subassembly 260 may be fixed to the housing 242 at another location. For example, the energy-absorbing elements 246 of the first plurality of energy-absorbing elements may be fixed to the first wall 252 of the first component 250, as described above with respect to the energy-absorbing assembly 180 of FIG. 5.

Use of the flanged carrier plate 244 facilitates greater flexibility in fixing the subassembly 260 to the housing 242. More particularly, the flanged carrier plate 244 can be fixed anywhere on the first component 250 or the second component 254. A position of the carrier plate 244 is not limited by the position of the outwardly-extending flanges 258 of the housing 242, nor does it rely on fixing the first plurality of energy-absorbing elements 246 to the first wall 252 of the first component 250. The flanged carrier plate 244 changes the loading path during crush and may therefore be particularly suitable for certain anticipated loading conditions. Although the energy-absorbing assembly 240 is shown as described as being a multi-stage energy-absorbing assembly, the flanged carrier plate 244 may also be used with other configurations of energy-absorbing elements described herein.

Some energy-absorbing assemblies according to various aspects of the present disclosure may be optimized for loads that are applied in a direction that is substantially parallel to the ground and substantially perpendicular to an outer wall of a housing of the energy-absorbing assembly (see, e.g., energy-absorbing assemblies 10, 50, 100, 140, 180, 240 of FIGS. 1, 2A, 3A, 4, 5, 6, respectively). However, other energy-absorbing assemblies may be optimized for loads that are applied non-parallel to the ground and/or non-perpendicular to the outer wall of the housing.

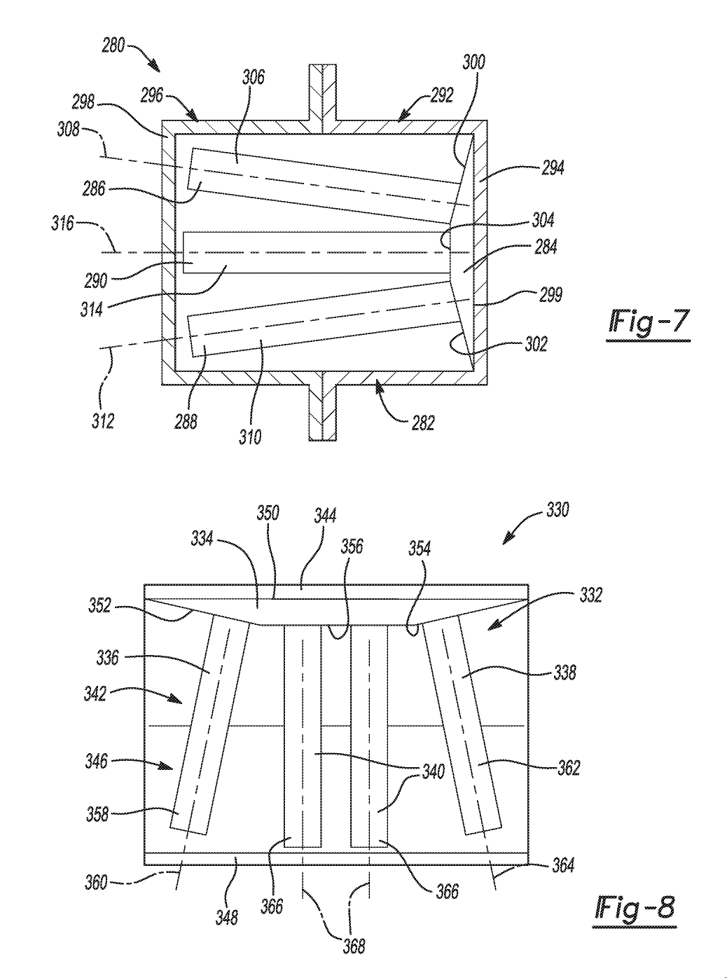

Referring to FIG. 7, still another energy-absorbing assembly 280 according to certain aspects of the present disclosure is provided. The energy-absorbing assembly 280 may include a housing 282, a carrier plate 284, a first plurality of energy-absorbing elements 286, a second plurality of energy-absorbing elements 288, and a third plurality of energy-absorbing elements 290. The carrier plate 284 may be formed from or include a first polymer and a first plurality of reinforcing fibers. The first plurality of energy-absorbing elements 286 may be formed from or include a second polymer and a second plurality of reinforcing fibers. The second plurality of energy-absorbing elements 288 may be formed from or include a third polymer and a third plurality of reinforcing fibers. The third plurality of energy-absorbing elements 290 may be formed from or include a fourth polymer and a fourth plurality of reinforcing fibers.

The housing 282 may include a first component 292 including a first wall 294 and a second component 296 including a second wall 298. The carrier plate 284 may include a first surface 299, a second surface 300, a third surface 302, and a fourth surface 304. In various aspects, the first, second, third, and fourth surfaces 299, 300, 302, 304 may each be substantially planar. The second, third, and fourth surfaces 300, 302, 304 may be disposed opposite the first surface 299. The second surface 300 may extend substantially non-parallel to the third surface 302. The fourth surface 304 may be disposed between and connect the second surface 300 and the third surface 302. The fourth surface 304 may extend substantially parallel to the first surface 299. The first surface 299 of the carrier plate 284 may be fixed to the first wall 294 and extend substantially parallel to the first wall 294.

The energy-absorbing elements 286 of the first plurality of energy-absorbing elements may each include a first elongated hollow structure 306 defining a first longitudinal axis 308. The first plurality of energy-absorbing elements 286 may be fixed to the second surface 300 of the carrier plate 284 such that the respective first longitudinal axes 308 extend substantially perpendicular to the second surface 300 of the carrier plate 284. The energy-absorbing elements 288 of the second plurality of energy-absorbing elements may each include a second elongated hollow structure 310 defining a second longitudinal axis 312. The energy-absorbing elements 288 of the second plurality of energy absorbing elements may be fixed to the third surface 302 of the carrier plate 284 such that the respective second longitudinal axes 312 extend substantially perpendicular to the third surface 302 of the carrier plate 284. The energy-absorbing elements 290 of the third plurality of energy-absorbing elements may each include a third elongated hollow structure 314 defining a third longitudinal axis 316. The energy-absorbing elements 290 of the third plurality of energy-absorbing elements may be fixed to the fourth surface 304 of the carrier plate 284 such that the respective fourth longitudinal axes 316 extend substantially perpendicular to the fourth surface 304 of the carrier plate 284.

By way of non-limiting example, the energy-absorbing assembly 280 may be a rocker assembly or a portion of a rocker assembly fixed to a side a vehicle. The first component 292 of the housing 282 may be fixed to the vehicle. The first plurality of energy-absorbing elements 286 may be angled upward with respect to a plane substantially parallel to the ground. The second plurality of energy-absorbing elements 288 may be angled downward with respect to the plane substantially parallel to the ground. The third plurality of energy-absorbing elements 290 may extend substantially parallel to the ground. Thus, the energy-absorbing assembly 280 may be optimized for upward and downward loads.

In various alternative aspects, the carrier plate 284 may define alternative shapes to orient the energy-absorbing elements 286, 288, 290 as desired with respect to the plane parallel to the ground. In one non-limiting example, the carrier plate may be bent or faceted and include a uniform thickness. In another non-limiting example, the carrier plate may include a smooth, curved surface rather than the second, third, and fourth distinct surfaces 300, 302, 304.

With reference to FIG. 8, another energy-absorbing assembly 330 is provided. Unless otherwise provided, the energy-absorbing assembly 330 may similar to the energy-absorbing assembly 280 of FIG. 7. The energy-absorbing assembly 330 may include a housing 332, a carrier plate 334, a first plurality of energy-absorbing elements 336, a second plurality of energy-absorbing elements 338, and a third plurality of energy-absorbing elements 340. The housing 332 may include a first component 342 including a first wall 344 and a second component 346 including a second wall 348.

The carrier plate 334 may include a first surface 350, a second surface 352, a third surface 354, and a fourth surface 356. The second, third, and fourth surfaces 352, 354, 356 may be disposed opposite the first surface 350. The first surface 350 of the carrier plate 334 may be fixed to the first wall 344 of the first component 342.

Each energy-absorbing element 336 of the first plurality of energy-absorbing elements may include a first elongated hollow structure 358 defining a first longitudinal axis 360. The first plurality of energy-absorbing elements 336 may be fixed to the second surface 352 of the carrier plate 334 such that the respective first longitudinal axes 360 extend substantially perpendicular to the second surface 352 of the carrier plate 334. Each energy-absorbing element 338 of the second plurality of energy-absorbing elements may include a second elongated hollow structure 362 defining a second longitudinal axis 364. The second plurality of energy-absorbing elements 338 may be fixed to the third surface 354 of the carrier plate 334 such that the respective second longitudinal axes 364 extend substantially perpendicular to the third surface 354 of the carrier plate 334. Each energy-absorbing element 340 of the third plurality of energy-absorbing elements may include a third elongated hollow structure 366 defining a third longitudinal axis 368. The third plurality of energy-absorbing elements 340 may be fixed to the fourth surface 356 of the carrier plate 334 such that the respective third longitudinal axes 368 extend substantially perpendicular to the fourth surface 356 of the carrier plate 334.

By way of non-limiting example, the energy-absorbing assembly 330 may be a rocker assembly or a portion of a rocker assembly fixed to a side of a vehicle. The first component 342 of the housing 332 may be fixed to the vehicle. The first plurality of energy-absorbing elements 336 may be angled backward with respect to a cross-car plane. The second plurality of energy-absorbing elements 338 may be angled forward with respect to the cross-car plane. The third plurality of energy-absorbing elements 340 may extend substantially parallel to the cross-car plane. Thus, the energy-absorbing assembly 330 may be optimized to for frontward and rearward loads.

In certain variations, an energy-absorbing assembly may include a plurality of substantially identical energy-absorbing elements that are distributed uniformly within a housing (see, e.g., energy-absorbing assembly 10 of FIG. 1). Each energy-absorbing element may include a thickness that is uniform or tapered along a longitudinal axis (e.g., having a smaller thickness at an outside end). However, in other variations, an energy-absorbing assembly may include two or more distinct or different types of energy-absorbing elements. Distinct energy-absorbing elements may have different shapes (e.g., cylindrical, frusto-conical), sizes (e.g., length, diameter, thickness, rate of change of thickness along the longitudinal axis), features (e.g., flange), and/or materials of construction (e.g., polymer and/or reinforcing fiber) by way of non-limiting example. The energy-absorbing assembly may also include energy-absorbing elements that are non-uniformly distributed.

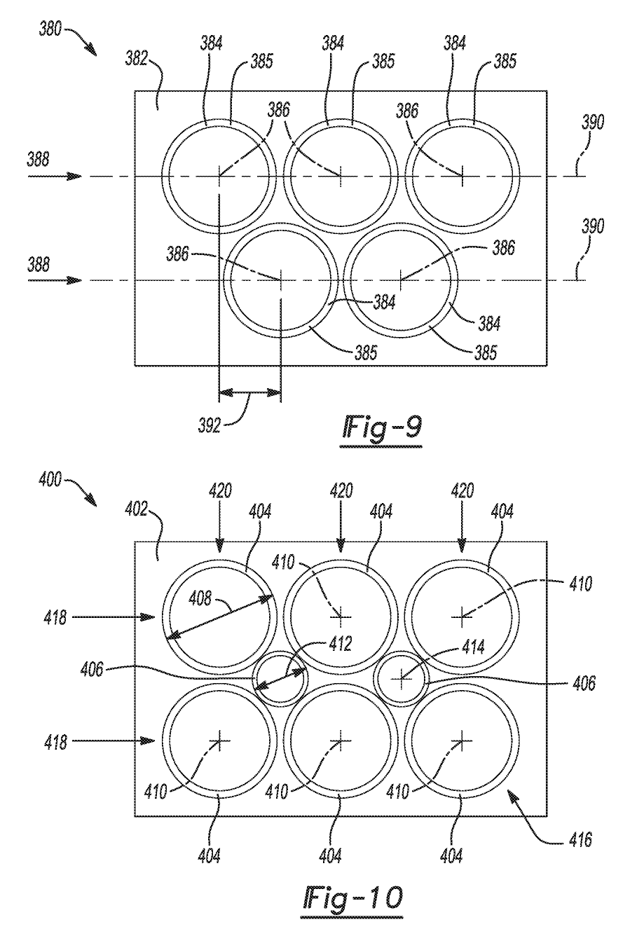

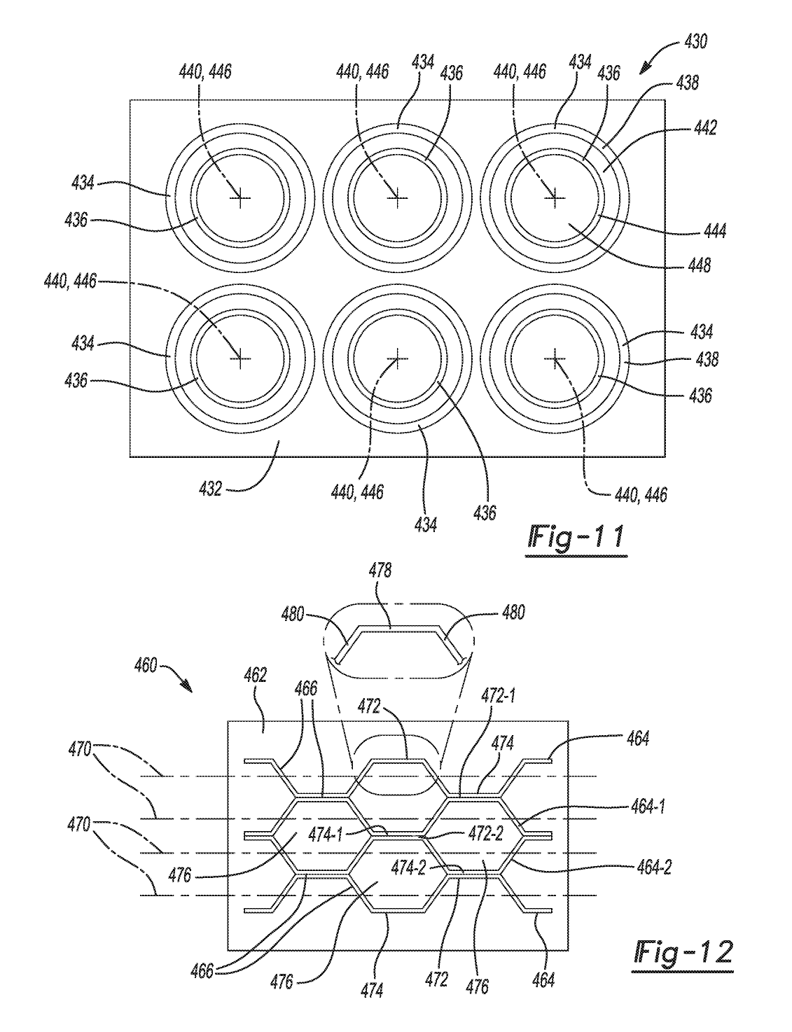

The energy-absorbing elements may be arranged so that a peripheral wall of one energy-absorbing element directly contacts respective peripheral walls of adjacent energy-absorbing elements. Alternatively, the energy-absorbing elements may be arranged so that peripheral walls of respective energy-absorbing elements are spaced apart from one another (i.e., not in direct contact with one another). Furthermore, the arrangement of the energy-absorbing elements with respect to one another is not limited to the arrangements shown and described herein. By way of non-limiting example, energy-absorbing elements can be distributed: (1) with the respective longitudinal axes parallel to one another (see, e.g., FIG. 1); (2) in offset rows, so that the energy-absorbing elements are as close as possible to one another (see, e.g., FIG. 9); (3) in a space-filling arrangement with mixed diameters (see, e.g., FIG. 10); (4) in nested arrangement with mixed diameters (see, e.g., FIG. 11); (5) mixed, sporadic, or random, depending on the expected crush or load conditions.

Referring to FIG. 9, an energy-absorbing subassembly 380 according to certain aspects of the present disclosure is provided. The energy-absorbing subassembly 380 includes a carrier plate 382 and a plurality of energy-absorbing elements 384. Each energy-absorbing element 384 may include an elongated hollow structure 385 defining a longitudinal axis 386. The energy-absorbing elements 384 may be arranged in rows 388, which may be offset. In each row, the respective longitudinal axes 386 of a portion of the energy-absorbing elements 384 of the plurality of energy-absorbing elements are aligned in a common plane 390. Each row 388 is offset from each adjacent row 388 in a direction perpendicular to the common plane 390 by an amount 392. In various aspects, the arrangement energy-absorbing elements 384 in the energy-absorbing subassembly 380 may be referred to as an “offset arrangement.” The offset arrangement may facilitate closer spacing between energy-absorbing elements 384 than the aligned configuration of FIG. 1. The energy-absorbing subassembly 380 may be fixed to a housing similar to any of the housings described herein to form an energy-absorbing assembly.

With reference to FIG. 10, another energy-absorbing subassembly 400 according to certain aspects of the present disclosure is provided. The energy-absorbing subassembly 400 may include a carrier plate 402, a first plurality of energy-absorbing elements 404, and a second plurality of energy-absorbing elements 406. The energy-absorbing elements 404 of the first plurality of energy-absorbing elements may have respective first outer diameters 408 in a direction substantially perpendicular to respective first longitudinal axes 410. The energy-absorbing elements 406 of the second plurality of energy-absorbing elements may have respective second outer diameters 412 in a direction substantially perpendicular to respective second longitudinal axes 414. The first diameter 408 and the second diameter 412 may have distinct magnitudes. The second diameter 412 may be less than the first diameter 408.

The energy-absorbing elements 406 of the second plurality of energy-absorbing elements may be partially disposed between the energy-absorbing elements 404 of the first plurality of energy-absorbing elements. Each energy-absorbing element 406 of the second plurality of energy-absorbing elements may be surrounded by four energy-absorbing elements 404 of the first plurality of energy-absorbing elements. More specifically, the energy-absorbing elements 404 of the first plurality of energy-absorbing elements may be disposed in a grid 416 having rows 418 and columns 420. The energy-absorbing elements 406 of the second plurality of energy-absorbing elements may be disposed between the rows 418 and the columns 420. The energy-absorbing subassembly 400 may be fixed to a housing similar to any of the housings described herein to form an energy-absorbing assembly.

Such an arrangement of energy-absorbing elements 404, 406 may maximize a quantity of energy-absorbing elements in a given volume (i.e., increase a density of energy-absorbing elements). Where energy-absorbing elements are closer to one another (i.e., present in higher densities within a given volume), crush performance of the energy absorbing assembly including the energy-absorbing subassembly 400 may increase. In various aspects, the arrangement of energy-absorbing elements 404, 406 of the energy-absorbing subassembly 400 may be referred to as a “space-filling arrangement.” In various alternative aspects, the energy-absorbing subassembly 400 may further include additional pluralities of energy-absorbing elements of decreasing diameter disposed interstitially with respect to larger-diameter energy-absorbing elements.

With reference to FIG. 11, yet another energy-absorbing subassembly 430 according to certain aspects of the present disclosure is provided. The energy-absorbing subassembly 430 may include a carrier plate 432, a first plurality of energy-absorbing elements 434, and a second plurality of energy-absorbing elements 436. Each of the energy-absorbing elements 434 of the first plurality of energy-absorbing elements may include a first elongated hollow structure 438 defining a first longitudinal axis 440 and a first inner area 442. Each of the energy-absorbing elements 436 of the second plurality of energy-absorbing elements may include a second elongated hollow structure 444 defining a second longitudinal axis 446 and a second inner area 448. Each energy-absorbing element 436 of the second plurality of energy-absorbing elements may be nested within a respective energy-absorbing element 434 of the first plurality of energy-absorbing elements and disposed within the first inner area 442. In certain aspects, the first and second pluralities of energy-absorbing elements 434, 436 may be concentrically disposed such that the first longitudinal axes 440 are aligned with the second longitudinal axes 446, respectively. However, in alternative aspects, the second plurality of energy-absorbing elements 436 may be nested within and non-concentrically disposed with respect to the first plurality of energy-absorbing elements 434, respectively, such that the first and second longitudinal axes 440, 446 are not aligned. The first and second elongated hollow structures 438, 444 may be spaced apart so that they are not touching. However, in various alternative aspects, the first and second elongated hollow structures 438, 444 may be in direct physical contact with one another. The energy-absorbing subassembly 430 may be fixed to a housing similar to any of the housings described herein to form an energy-absorbing assembly. In various aspects, the arrangement of energy-absorbing elements 434, 436 within the energy-absorbing subassembly 430 may be referred to as a “nested arrangement.”

In various alternative aspects, an energy-absorbing subassembly according to certain aspects of the present disclosure may include additional pluralities of nested energy-absorbing elements (not shown). For example, the energy-absorbing subassembly may include a first plurality of energy-absorbing elements, a second plurality of energy-absorbing elements nested within the first plurality of energy-absorbing elements, respectively, a third plurality of energy-absorbing elements nested within the second plurality of energy-absorbing elements, respectively, and a fourth plurality of energy-absorbing elements nested within the third plurality of energy-absorbing elements, respectively. In certain aspects, the first, second, third, and fourth pluralities of energy-absorbing elements may optionally have longitudinal axes that are aligned such that the first, second, third, and fourth pluralities of energy-absorbing elements are concentrically disposed with respect to one another.

In various alternative aspects, an energy-absorbing subassembly according to certain aspects of the present disclosure may include a first plurality of energy-absorbing elements, each having a respective inner area, with multiple energy-absorbing elements of a second plurality of energy-absorbing elements distributed within each inner area (not shown). The energy-absorbing subassembly may include the first plurality of energy-absorbing elements and the second plurality of energy-absorbing elements. Each energy-absorbing element of the first plurality of energy-absorbing elements may include a first elongated hollow structure defining a first diameter. Each energy-absorbing element of the second plurality of energy-absorbing elements may include a second elongated hollow structure defining a second diameter that is smaller than the first diameter. The first elongated hollow structure of each energy-absorbing element of the first plurality may define the inner area. Multiple energy-absorbing elements of the second plurality of energy-absorbing elements (e.g., two or three) may be disposed within each inner area and distributed throughout the inner area. Thus, in some variations, the energy-absorbing elements of the second plurality of energy-absorbing elements are not nested with respect to one another. The energy-absorbing elements of the second plurality of energy-absorbing elements within each inner area may be spaced apart from one another or alternatively have respective outer surfaces that are in direct physical contact (e.g., forming a honeycomb structure). In certain variations, the second elongated hollow structures may be stacked upon one another and therefore in contact with adjacent second elongated hollow structures. A quantity of energy-absorbing elements of the second plurality of energy-absorbing elements need not be the same within each inner area.

Each of the energy-absorbing assemblies and subassemblies described above includes energy-absorbing elements that each have respective elongated hollow structures. However, energy-absorbing elements may alternatively define other shapes, such as plates. With reference to FIG. 12, another energy-absorbing subassembly 460 according to certain aspects of the present disclosure is provided. The energy-absorbing subassembly 460 may include a carrier plate 462 and a plurality of energy-absorbing elements 464. Each energy-absorbing element 464 may be formed from or include a polymer and a plurality of reinforcing fibers, similar to those described with respect to the energy-absorbing elements 30 of the energy-absorbing assembly 10 of FIG. 1.

Each energy-absorbing element 464 may include a transverse wall 466 that extends across at least a portion of the carrier plate 462. In various aspects, when the energy-absorbing subassembly 460 is fixed within a housing to form an energy-absorbing assembly, the respective transverse walls 466 may extend through an interior compartment of the housing. The transverse wall 466 of each respective energy-absorbing element 464 may define a center plane 470. The center plane 470 of each transverse wall 466 may extend substantially non-parallel to the carrier plate 462. For example, the center plane 470 of each transverse wall 466 may extend substantially normal to the carrier plate 462. In various aspects, the energy-absorbing subassembly 460 may be fixed to a housing (not shown). The housing may be fixed to a vehicle operable to travel along a ground. The center plane 470 of the transverse wall 466 may extend substantially parallel to the ground.

The transverse wall 466 of each energy-absorbing element 464 may define a plurality of elongated ridges or peaks 472. Each elongated ridge 472 of the plurality of elongated ridges may be spaced apart from other elongated ridges 472 of the plurality of elongated ridges at predetermined intervals. The transverse wall 466 of each of the energy-absorbing elements 464 may define a corrugated structure. Each elongated ridge 472 may extend substantially perpendicular to the carrier plate 462. A plurality of elongated floors or valleys 474 may be disposed between the plurality of elongated ridges 472 such that the elongated ridges 472 and the elongated floors 474 alternate with one another. In various aspects, the elongated ridges 472 and the elongated floors 474 may define a waveform shape. However, in various alternative aspects, the elongated ridges 472 may repeat at irregular intervals.

The orientations of adjacent energy-absorbing elements 464 may be mirrored so that elongated cells 476 are formed between two energy-absorbing elements 464. More particularly a first energy-absorbing element 464-1 of the plurality of energy-absorbing element may include first elongated ridges 472-1 and first elongated floors 474-1. A second energy-absorbing assembly 464-2 may include second elongated ridges 472-2 and second elongated floors 474-2. The first elongated ridges 472-1 of the first energy-absorbing element 464-1 may be aligned with the second elongated floors 474-2 of the second energy-absorbing element 464-2 to define the elongated cells 476. Similarly, the first elongated floors 474-1 of the first energy-absorbing element 464-1 may be aligned with the second elongated ridges 472-2 of the second energy-absorbing element 464-2. The first elongated floors 474-1 may engage the second elongated ridges 472-2. Each elongated ridge 472 may include a top wall 478 and two side walls 480. However, the elongated ridges 472 may alternatively define other shapes such as shapes having side walls disposed at different angles, shapes having different quantities of side walls, and smooth curves. In various alternative aspects, the transverse walls 466 may omit the elongated ridges 472 altogether and define other shapes, such as a planar sheet with uniform or non-uniform thickness.

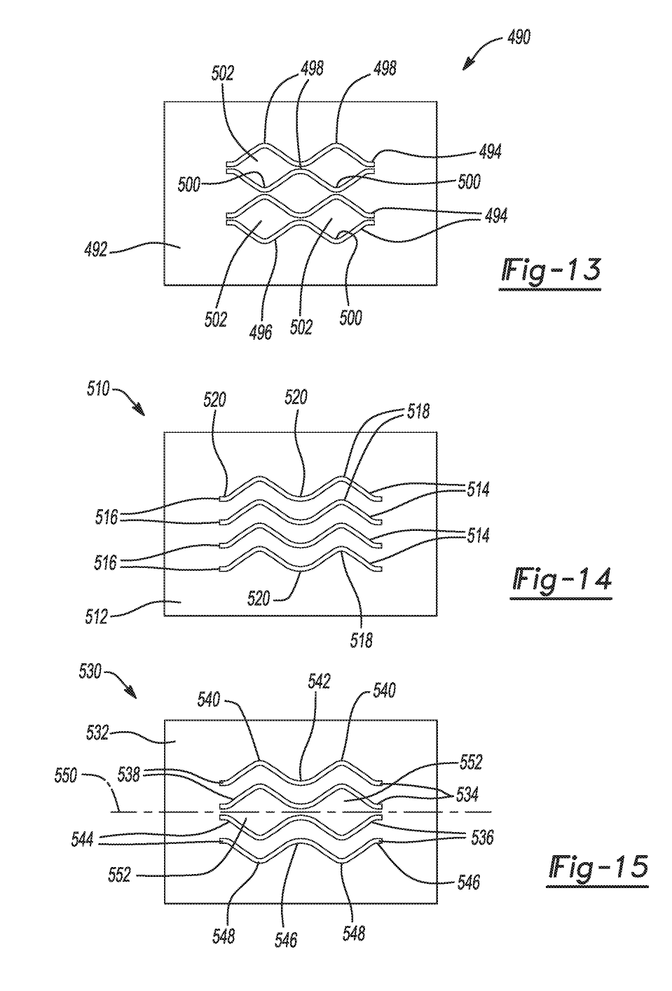

Referring to FIG. 13, another energy-absorbing subassembly 490 according to certain aspects of the present disclosure is provided. The energy-absorbing subassembly 490 may include a carrier plate 492 and a plurality of energy-absorbing elements 494. Unless otherwise provided, the energy-absorbing subassembly 490 may be similar to the energy-absorbing subassembly 460 of FIG. 12.

Each energy-absorbing element 494 may include a transverse wall 496. The transverse wall 496 of each energy-absorbing element 494 may include a plurality of elongated ridges 498 and a plurality of elongated floors 500 arranged to define a plurality of elongated cells 502. However, unlike the transverse walls 466 of FIG. 12, the transverse walls 496 define smooth curves transitioning between the elongated ridges 498 and the elongated floors 500. By way of non-limiting example, the transverse wall 496 of each energy-absorbing element 494 may define a sine wave.

Energy-absorbing elements defining transverse walls with elongated ridge may alternatively be arranged in other manners. Instead of being arranged to defining a plurality of elongated cells, as in FIGS. 12-13, respective elongated ridges of each transverse wall may be aligned with one another. Referring to FIG. 14, yet another energy-absorbing subassembly 510 according to certain aspects of the present disclosure is provided. The energy-absorbing subassembly 510 may include a carrier plate 512 and a plurality of energy-absorbing elements 514. Unless otherwise provided, the energy-absorbing subassembly 510 may be similar to the energy-absorbing subassembly 490 of FIG. 13.

Each energy-absorbing element 514 may include a transverse wall 516 defining a plurality of elongated ridges 518 and a plurality of elongated floors 520. The elongated ridges 518 of each energy-absorbing element 514 may be aligned with the respective elongated ridges 518 of each other energy-absorbing element 514. The energy-absorbing elements 514 may be arrangement such that respective opposing surfaces of adjacent transverse walls 516 complement one another.

With reference to FIG. 15, still another energy-absorbing subassembly 530 according to certain aspects of the present disclosure is provided. The energy-absorbing subassembly 530 may include a carrier plate 532, a first plurality of energy-absorbing elements 534, and a second plurality of energy-absorbing elements 536. Unless otherwise provided, the energy-absorbing elements 534, 536 may be similar to the energy-absorbing elements 514 of FIG. 14. Each energy-absorbing element of the first plurality of energy-absorbing elements 534 may include a first transverse wall 538 defining a first plurality of elongated ridges 540 and a first plurality of elongated floors 542. Each energy-absorbing element of the second plurality of energy-absorbing elements 536 may include a second transverse wall 544 defining a second plurality of elongated ridges 546 and a second plurality of elongated floors 548.

The energy-absorbing elements of the first plurality of energy-absorbing elements 534 may be arranged so that first elongated ridges 540 of each energy-absorbing element are respectively aligned with first elongated ridges 540 of each other energy-absorbing element of the second plurality of energy-absorbing elements 536. The energy-absorbing elements of the second plurality of energy-absorbing elements 536 may be arranged so that the second elongated ridges 546 of each energy-absorbing element 536 are respectively aligned with second elongated ridges 546 of each other energy-absorbing element of the second plurality of energy-absorbing elements 536. A mirror plane 550 may extend between the first plurality of energy absorbing elements 534 and the second plurality of energy-absorbing elements 536. The energy-absorbing elements of the second plurality of energy-absorbing elements 536 may be oriented such that they are mirrored with respect to the respective energy-absorbing elements of the first plurality of energy-absorbing elements 534. Thus, a single plurality of elongated cells 552 may be disposed between the first plurality of energy-absorbing elements 534 and the second plurality of energy-absorbing elements 536. The elongated cells 552 may be disposed along the mirror plane 550.

The energy-absorbing assemblies described herein may be selected from the group consisting of: a rocker, a bumper beam, A, B, C, or D pillars, header rails, roof rails, front rail sections, hollow cross-car beams, and combinations thereof. Although automotive applications are discussed, the energy-absorbing assemblies may also be used in other applications such as other vehicle applications (e.g., motorcycles and recreational vehicles), in the aerospace industry (e.g., airplanes, helicopters, drones), nautical applications (e.g., ships, personal watercraft, docks), agricultural equipment, industrial equipment, and the like.

In various aspects, the present disclosure may also provide methods of manufacturing and assembling the energy-absorbing assemblies of the present disclosure. When both the carrier plate and the plurality of energy-absorbing elements include a thermoplastic polymer, the energy-absorbing elements may be thermally joined to the carrier plate, as described in greater detail below. The use of thermal joining may desirably eliminate the need for adhesive or additional components such as mechanical fasteners, while resulting in a strong joint. The energy-absorbing elements and the carrier plate may include the same polymer, or polymers with similar properties to create a robust thermal joint. However, energy-absorbing elements may also be joined to a carrier plate via alternative methods, such as press fitting, particularly where the energy-absorbing elements and the carrier plate include dissimilar materials. A method of manufacturing an energy-absorbing assembly according to certain aspects of the present disclosure may include: (1) fabricating the carrier plate and the energy-absorbing elements; (2) fixing the energy-absorbing elements to the carrier plate to form an energy-absorbing subassembly; and (3) fixing the subassembly to a housing to form the energy-absorbing assembly. Steps (1) and (2) above may be performed remotely (e.g., at a distinct facility) with respect to step (3). Thus, the energy-absorbing subassembly can be remotely fabricated prior to final assembly with the housing to form the energy-absorbing assembly. Pre-fabrication of the energy-absorbing subassembly may advantageously permit a quick and accurate assembly of the energy-absorbing subassembly. Pre-fabrication of the energy-absorbing subassembly including the energy-absorbing elements and the carrier plate may facilitate proper positioning of the energy-absorbing elements with respect to the carrier plate, and ultimately with respect to the housing. The energy-absorbing subassembly can be aligned and fixed within the housing as a single unit, thereby reducing time and opportunity for error.

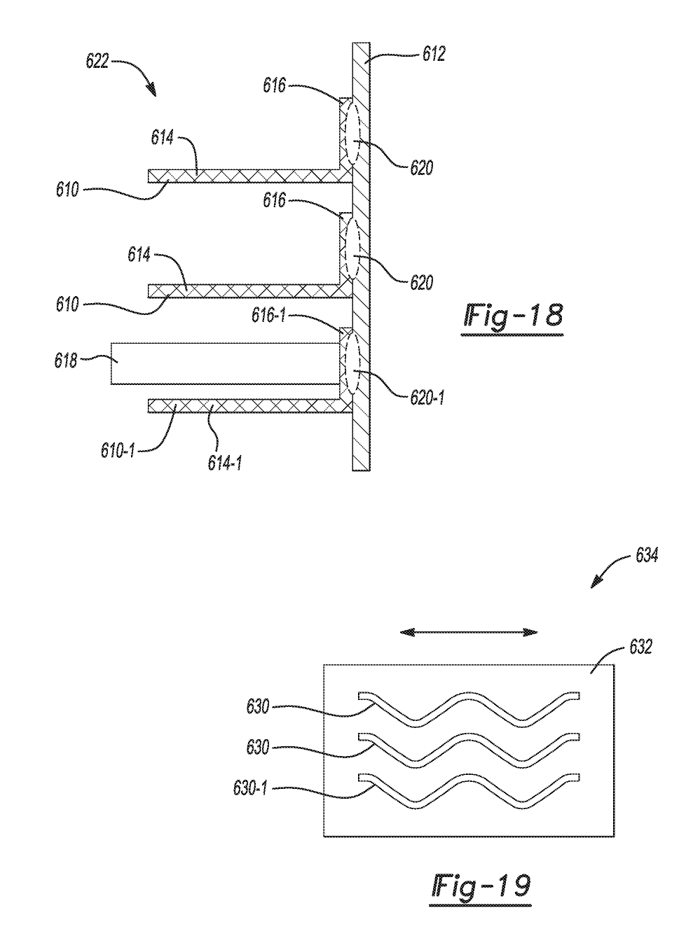

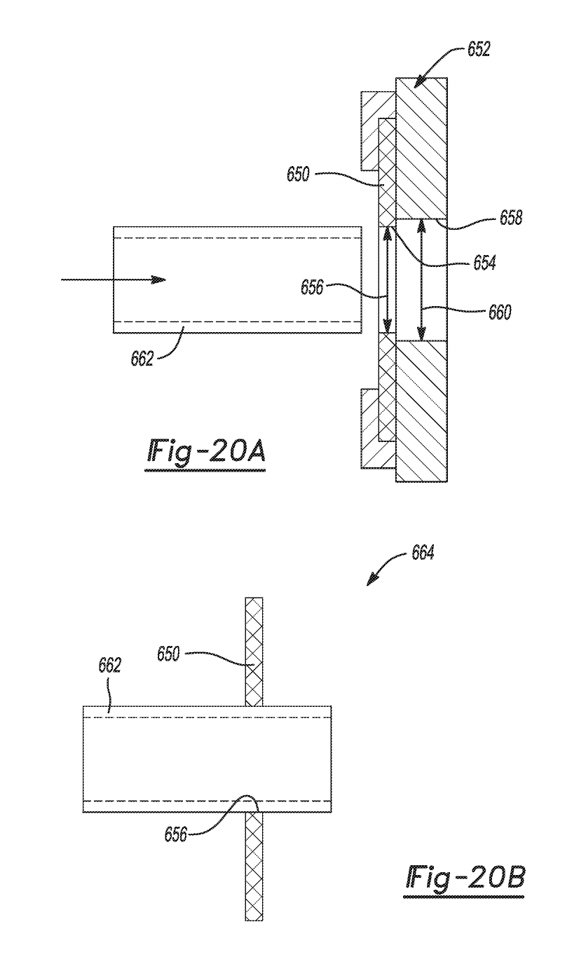

Fabricating the carrier plate and the energy-absorbing elements may include compression molding, resin transfer mold (RTM), high-pressure resin transfer molding (HP-RTM), injection molding, wet layup molding, autoclave molding, or any other suitable composites manufacturing method known to those skilled in the art. The carrier plate and the energy-absorbing elements may be fabricating using the same type of manufacturing process or distinct manufacturing processes. Fixing the energy-absorbing elements to the carrier plate to form the subassembly may include thermal joining where the carrier plate and the energy-absorbing elements include compatible thermoplastic polymers, or other methods. Thermal joining may include spin welding (FIGS. 16A-16C), ultrasonic welding (FIGS. 17A-17C and FIG. 18), vibration welding (FIG. 19), resistance welding, and induction welding, by way of non-limiting example. Other joining methods may include press fitting (FIGS. 20A-20B) or the use of adhesives and/or mechanical fasteners. The above joining methods may be used individually or in combination with one another.

Referring to FIGS. 16A-16C, a method of assembling an energy-absorbing subassembly via spin welding according to certain aspects of the present disclosure is provided. Spin welding may be used when the carrier plate and the plurality of energy-absorbing elements both include a thermoplastic polymer and when the desired joint is rotationally symmetric (i.e., when each energy-absorbing element includes an elongated hollow structure having a substantially-circular cross section).

At FIG. 16A, a carrier plate 560 may be placed into an anvil or fixture 562. The carrier plate 560 may include a planar surface 563 or a surface defining a plurality of depressions (not shown) for engaging a plurality of energy-absorbing elements 564. The energy-absorbing elements 564 may be open at both ends, or may alternatively include a flange to increase a joining area (see, e.g., flange 590 of energy-absorbing element 584 of FIG. 17B). A first energy-absorbing element 564-1 may be placed into a desired position with respect to the carrier plate 560. A spin welding chuck 566, which may include an internal clamp, may be disposed within an inner area 568 of the first energy-absorbing element 564-1. The spin welding chuck 566 may rotate the first energy-absorbing element 564-1 with respect to the carrier plate 560 while applying pressure along a longitudinal axis 569 of the first energy-absorbing element 564-1. The rotation may create friction, thereby generating heat and at least partially melting the thermoplastic polymers of the carrier plate and the first energy-absorbing elements 564-1. Thus, the thermoplastics polymers of the carrier plate 560 and the first energy-absorbing element 564-1 may melt together to form a first joint 570-1. At FIG. 16B, the process of FIG. 16A may be repeated to fix a second energy-absorbing element 564-2 to the carrier plate 560 to form a second joint 570-2. The process of FIG. 16A may be repeated to fix additional energy-absorbing elements to the carrier plate 560. At FIG. 16C, an energy-absorbing subassembly 572 may include the carrier plate 560 and the plurality of energy-absorbing elements 564.

Another method of assembling an energy-absorbing subassembly may include ultrasonic spot welding. Ultrasonic spot welding may be used when a carrier plate and a plurality of energy-absorbing elements both include a thermoplastic polymer. Ultrasonic spot welding may be used when the energy-absorbing elements include elongated hollow structures (FIGS. 17A-17C) or transverse walls (FIG. 18).

Referring to FIGS. 17A-17C, a method of joining a plurality of energy-absorbing elements, each including an elongated hollow structure, to a carrier plate to form an energy-absorbing subassembly via ultrasonic spot welding according to certain aspects of the present disclosure is provided. At FIG. 17A, a carrier plate 580 may be placed into an anvil or fixture 582. At FIG. 17B, an energy-absorbing element 584 may be placed into a desired position with respect to the carrier plate 580. The energy-absorbing element 584 may include an elongated hollow structure 586 defining a longitudinal axis 587 and an inner area 588. The energy-absorbing element 584 may further include a radially-extending flange 590. The flange 590 may extend radially inwardly to form an end cap. However, in various alternative aspects, the flange 590 may extend radially outwardly. An annular holding clamp 592 defining a central opening 594 may be inserted into the inner area 588 of the energy-absorbing element 584 and pressure may be applied along the longitudinal axis 587.

At FIG. 17C, an ultrasonic joining tool 596 may extend through the central opening 594 of the annular holding clamp 592 and into the inner area 588 of the energy-absorbing element 584. The ultrasonic joining tool 596 may apply high-frequency, ultrasonic, acoustic vibrations to create a solid state weld 598 to fix the energy-absorbing element 584 to the carrier plate 580. The steps of FIGS. 17B-17C may be repeated to join additional energy-absorbing elements 584 to the carrier plate 580 to form an energy-absorbing subassembly.

With reference to FIG. 18, a method of joining a plurality of energy-absorbing elements, each including a transverse wall, to a carrier plate to form an energy-absorbing subassembly via ultrasonic welding according to certain aspects of the present disclosure is provided. A first energy-absorbing element 610-1 may be placed into a desired position with respect to a carrier plate 612. The first energy-absorbing element 610-1 may include a first transverse wall 614-1 and a first elongated flange 616-1. Pressure may be applied to the first energy-absorbing element 610-1. An ultrasonic joining tool 618 may be disposed near the first flange 616-1. The ultrasonic joining tool 618 may apply high-frequency, ultrasonic, acoustic vibrations to create a first solid state weld 620-1 to fix the first energy-absorbing element 610-1 to the carrier plate 612. The above process may be used to fix a plurality of energy-absorbing elements 610 to the transverse plate 612 to form an energy-absorbing subassembly 622, where each energy-absorbing element 610 includes a respective transverse wall 614 and flange 616, and is fixed to the carrier plate 612 by a solid state weld 620.

Another method of assembling an energy-absorbing subassembly may include vibration welding. Vibration welding may be used when a carrier plate and a plurality of energy-absorbing elements both include thermoplastic polymers. Referring to FIG. 19, a first energy-absorbing element 630-1 of a plurality of energy-absorbing elements 630 may be placed onto a carrier plate 632 so that it extends substantially perpendicular to the carrier plate 632. At least one of the first energy-absorbing element 630-1 and the carrier plate 632 may be translated back and forth under pressure with respect to the other of the energy-absorbing element 630 and the carrier plate 632 to form a joint between the energy-absorbing element 630 and the carrier plate 632. The energy-absorbing element 630 may be joined to the carrier plate 632 directly at an edge of the energy-absorbing element 630. However, in alternative embodiments, the energy-absorbing element 630 may be provided with a flange to increase an area of the joint. Each of the energy-absorbing elements 630 may be joined to the carrier plate 632 to form an energy-absorbing subassembly 634.

Yet another method of assembling an energy-absorbing subassembly may include press-fitting a plurality of energy-absorbing elements into a respective plurality of apertures in a carrier plate. Press-fitting may be used to assemble an energy-absorbing subassembly regardless of the materials of construction of the energy-absorbing elements and the carrier plate. Thus, press-fitting may be used to join a plurality of energy-absorbing elements and a carrier plate of dissimilar materials.

Referring to FIGS. 20A-20B, a method of assembling a subassembly via press fitting according to certain aspects of the present disclosure is provided. At FIG. 20A, a carrier plate 650 may be placed into an anvil or fixture 652. The carrier plate 650 may define a first opening 654 having a first diameter 656. The anvil 652 may define a second opening 658 having a second diameter 660 that is larger than the first diameter 656. An energy-absorbing element 662 is pressed through the first opening 654. The method of FIG. 20A may be repeated to fix additional energy-absorbing elements 662 to the carrier plate 650 to form an energy-absorbing subassembly 664, as shown in FIG. 20B. In certain aspects, where the carrier plate 650 and the plurality energy-absorbing elements 662 each include a thermoplastic polymer, the press fitting may be combined with other methods to form a thermal joint, such as heating and/or spin welding.

Any of the subassemblies formed above (FIGS. 16A-20B) may be assembled to a housing to form an energy-absorbing assembly. As described above, the subassembly can be fixed to the housing at the carrier plate, the energy-absorbing elements, or both the carrier plate and the energy-absorbing elements. The fixing may include the use of adhesive, mechanical fasteners, thermal joining, or other methods known to those skilled in the art, depending on the respective materials of construction. Suitable adhesives may include adhesives based on methacrylate, urethane, or epoxy chemistries, by way of non-limiting example.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An energy-absorbing assembly for a vehicle comprising:
a carrier plate comprising a first polymer and a first plurality of reinforcing fibers; and
a first plurality of discrete energy-absorbing elements each comprising a second polymer and a second plurality of reinforcing fibers, the first plurality of energy-absorbing elements being fixed to the carrier plate, each energy-absorbing element of the first plurality of energy-absorbing elements comprising a first elongated hollow structure defining a first longitudinal axis extending nonparallel to the carrier plate.

2. The energy-absorbing assembly of claim 1, wherein the carrier plate defines a plurality of apertures, the first elongated hollow structure of each energy-absorbing element of the first plurality of energy-absorbing elements extending through a respective aperture of the plurality of apertures in the carrier plate.

3. The energy-absorbing assembly of claim 1, further comprising:
a second plurality of discrete energy-absorbing elements each comprising a third polymer and a third plurality of reinforcing fibers, the second plurality of energy-absorbing elements being fixed to the carrier plate, each energy-absorbing element of the second plurality of energy-absorbing elements comprising a second elongated hollow structure, the second elongated hollow structure defining a second longitudinal axis extending nonparallel to the carrier plate, wherein:
the carrier plate includes a first surface and a second surface;
each energy-absorbing element of the first plurality of energy-absorbing elements is fixed to the second surface of the carrier plate; and
each energy-absorbing element of the second plurality of energy-absorbing elements is fixed to the first surface of the carrier plate.

4. The energy-absorbing assembly of claim 1, wherein:
the carrier plate includes a first surface and a second surface, one of the first surface and the second surface defining a plurality of depressions; and
at least a portion of the energy-absorbing elements of the first plurality of energy-absorbing elements are partially disposed within respective depressions of the plurality of depressions.

5. The energy-absorbing assembly of claim 1, wherein:
the carrier plate includes a first surface and a second surface, one of the first surface and the second surface including a planar portion;
at least a portion of the energy-absorbing elements of the first plurality of energy-absorbing elements are fixed to the planar portion of the carrier plate; and
the first longitudinal axes of the at least a portion of the energy-absorbing elements of the first plurality of energy-absorbing elements extend substantially perpendicular to the planar portion of the carrier plate.

6. The energy-absorbing assembly of claim 1, further comprising a housing comprising a first wall and a second wall, the first wall and the second wall being spaced apart from one another to at least partially define an interior compartment, wherein the carrier plate and the first plurality of energy-absorbing elements are at least partially disposed within the interior compartment and the carrier plate is fixed to the housing.

7. The energy-absorbing assembly of claim 6, wherein:
the first wall of the housing is disposed nonparallel with respect to the second wall of the housing, the first wall forming an angle with respect to the second wall;
the carrier plate includes a first surface and a second surface, the first surface being disposed at the angle with respect to the second surface;
the first surface of the carrier plate is fixed to the first wall of the housing; and
the energy-absorbing elements of the first plurality of energy-absorbing elements are fixed to the second surface of the carrier plate, the longitudinal axes of the energy-absorbing elements of the first plurality of energy-absorbing elements extending substantially perpendicular to the second surface of the carrier plate.

8. The energy-absorbing assembly of claim 6, further comprising a second plurality of discrete energy-absorbing elements each comprising a third polymer and a third plurality of reinforcing fibers, the second plurality of energy-absorbing elements being fixed to the carrier plate, each energy-absorbing element of the second plurality of energy-absorbing elements comprising a second elongated hollow structure, the second elongated hollow structure defining a second longitudinal axis extending nonparallel to the carrier plate, wherein:
the carrier plate includes a first surface, a second surface, and a third surface, the third surface extending nonparallel to the second surface;
the first surface of the carrier plate is fixed to the first wall;
the first plurality of energy-absorbing elements is fixed to the second surface of the carrier plate;
the second plurality of energy-absorbing elements is fixed to the third surface of the carrier plate; and
the first longitudinal axes of the energy-absorbing elements of the first plurality of energy-absorbing elements extend non-parallel to the second longitudinal axes of the energy-absorbing elements of the second plurality of energy-absorbing elements.

9. The energy-absorbing assembly of claim 6, wherein:
the housing further comprises a first component and a second component, the first component and the second component cooperating to define the interior compartment;
the first component comprises the first wall, a first outwardly-extending flange, and a second outwardly-extending flange and the second component comprises the second wall, a third outwardly-extending flange, and a fourth outwardly-extending flange;
the first outwardly-extending flange extends substantially parallel to the third outwardly-extending flange and the second outwardly-extending flange extends substantially parallel to the fourth outwardly-extending flange;
a first portion of the carrier plate is disposed between the first outwardly-extending flange and the third outwardly-extending flange and fixed to the first outwardly-extending flange and the third outwardly-extending flange; and
a second portion of the carrier plate is disposed between the second outwardly-extending flange and the fourth outwardly-extending flange and fixed to the second outwardly-extending flange and the fourth outwardly-extending flange.

10. The energy-absorbing assembly of claim 6, wherein the carrier plate includes a first carrier flange and a second carrier flange, each of the first carrier flange and the second carrier flange being fixed to an interior surface of the housing to fix the carrier plate to the housing.

11. The energy-absorbing assembly of claim 1, wherein each energy-absorbing element of the first plurality of energy-absorbing elements includes a radially-extending flange, the radially-extending flange being fixed to a surface of the carrier plate.

12. The energy-absorbing assembly of claim 1, wherein the first polymer is a first thermoplastic polymer and the second polymer is a second thermoplastic polymer.

13. An energy-absorbing assembly for a vehicle comprising:
a carrier plate comprising a first polymer and a first plurality of reinforcing fibers; and
a plurality of discrete energy-absorbing elements each comprising a second polymer and a second plurality of reinforcing fibers, the plurality of energy-absorbing elements being fixed to the carrier plate, each energy-absorbing element of the plurality of energy-absorbing elements comprising a transverse wall.

14. The energy-absorbing assembly of claim 13, wherein the respective transverse wall of each energy-absorbing element includes a plurality of elongated ridges formed therein, each elongated ridge of the plurality of elongated ridges being spaced apart from other elongated ridges of the plurality of elongated ridges at predetermined intervals.

15. The energy-absorbing assembly of claim 13, further comprising a housing comprising a first wall and a second wall, the first wall and the second wall being spaced apart from one another to at least partially define an interior compartment, wherein the carrier plate and the plurality of energy-absorbing elements are at least partially disposed within the interior compartment and the carrier plate is fixed to the housing.

16. A method of assembling an energy-absorbing subassembly for a vehicle, the method comprising:
disposing a plurality of energy-absorbing elements on a carrier plate, the carrier plate comprising a first polymer and a first plurality of reinforcing fibers, each energy-absorbing element of the plurality of energy-absorbing elements comprising a second polymer and a second plurality of reinforcing fibers, each energy-absorbing element of the plurality of energy-absorbing elements extending substantially perpendicular to the carrier plate; and
fixing each of the energy-absorbing elements of the plurality of energy-absorbing elements to the carrier plate to form the energy-absorbing subassembly, wherein the first polymer and the second polymer each include a thermoplastic polymer.

17. The method of claim 16, wherein each of the energy-absorbing elements of the plurality of energy-absorbing elements includes an elongated hollow structure defining a longitudinal axis, and the fixing each of the energy-absorbing elements of the plurality of energy-absorbing elements to the carrier plate includes spin welding to form a thermal joint.

18. The method of claim 16, wherein each of the energy-absorbing elements of the plurality of energy-absorbing elements includes an elongated hollow structure defining a longitudinal axis and a radially-extending flange disposed at an end of the elongated hollow structure, and the fixing each of the energy-absorbing elements of the plurality of energy-absorbing elements to the carrier plate includes ultrasonic welding to form a thermal joint.

19. The method of claim 16, wherein each of the energy-absorbing elements of the plurality of energy-absorbing elements includes a transverse wall and a flange disposed at an end of the transverse wall, and the fixing each of the energy-absorbing elements of the plurality of energy-absorbing elements to the carrier plate includes ultrasonic welding to form a thermal joint.

20. The method of claim 16, wherein each of the energy-absorbing elements of the plurality of energy-absorbing elements includes a transverse wall, and the fixing each of the energy-absorbing elements of the plurality of energy-absorbing elements to the carrier plate includes vibration welding to form a thermal joint.
